(19) United States
(12) Patent Application Publication
(10) Pub. No.: US 2006/0066850 A1
(43) Pub. Date: Mar. 30, 2006

(54) Light measuring device, biochemical analyzer, biochemical analysis method, and spectrophotometer

(75) Inventor: Muneyasu Kimura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/231,906

(22) Filed: Sep. 22, 2005

(30) Foreign Application Priority Data
Sep. 29, 2004 (JP) 2004-285156
Sep. 29, 2004 (JP) 2004-285157
Sep. 29, 2004 (JP) 2004-285158

(51) Int. Cl. G01J 3/28

(52) U.S. Cl. 356/328

(57) ABSTRACT

A biochemical analyzer includes an optical assay unit for light measurement by use of an analysis slide and an LED light source. A fluid sample is positioned on an assay surface of the analysis slide. The light source is oriented to tilt with respect to the assay surface, for applying illuminating light thereto. The optical assay unit includes a photo diode, positioned vertically under the assay surface, for measuring scattered reflected light of diffuse reflection from the assay surface. A light absorber is positioned in a light path of the light emitted by the LED light source and reflected in regular reflection by the assay surface, for absorbing the light. Furthermore, the light absorber is black with a low gloss. The photo diode responds to turning on of the light source, to output a signal of the scattered reflected light.

### BACKGROUND OF THE INVENTION

1. Field of the Invention

The present invention relates to a light measuring device, a biochemical analyzer, a biochemical analysis method, and a spectrophotometer. More particularly, the present invention relates to a light measuring device for use in a biochemical analyzer, which can be constructed with portability, and in which light can be measured with high precision, and also relates to a biochemical analyzer, a biochemical analysis method, and a spectrophotometer.

2. Description Related to the Prior Art

Recently, social concern in medical affaires has been focused on the Point Of Care Testing (POCT) in which samples are measured, tested or assayed in environment very near to locations of patients as locations of medical treatment, such as consultation rooms, wards or the like in various facilities including clinics, hospitals, sanatoriums and the like. The conception of POCT is characterized in simplicity over large-scale assay or test widely used in many hospitals for collectively measuring numerous samples in a central testing station. It is unnecessary for a patient to be inspected by visiting clinical facilities, and unnecessary for a doctor to send samples to testing facilities. As the assay or test is made near to patients, it is possible for doctors to treat diseases rapidly by finding results of the test without taking long time. Also, monitoring of the diseases is possible during or after the recovery of the patients. There are advantages in low costs for transporting samples and for installing equipment, and also in a small amount of each sample of blood or the like. An amount of blood required drawing from a body of a patient can be reduced. Various assay devices or systems are known for the purpose of POCT, for example a system for monitoring blood sugar of patients with diabetes.

FUJI DRI-CHEM 3500 (trade name) is manufactured by Fuji Photo Film Co., Ltd. and marketed as a biochemical analyzer of a portable type. This analyzer is adapted to analysis of 27 items of biochemical or immunological assay, and three (3) items of assay of electrolytes. There is a drawback of a large size of the analyzer body in spite of the great number of the items for analysis. The structure of the known analyzer is inconsistent to a wide use in various environment. Accordingly, there have been suggestions of portable types of biochemical analyzers associated with changes in the environments of the clinical medicine, and capable of quick inspection of patients in respective hospitals or clinics.

To develop a biochemical analyzer of a portable type, relevant elements included therein must be simplified for compact and lightweight structures. Also, electric power must be lowered because of the use of an inner power source, such as a battery, contained inside. There is a suggestion in JP-A 61-017046 for the biochemical analyzer. According to this, a lamp is used to illuminate in an optical assay unit, and requires a use of an interference filter, which is inserted in a path between the lamp to an assay surface or between the assay surface and a photoreceptor, for transmitting light of only a prescribed wavelength. Each time that a target biomaterial is changed over, the interference filter must be changed over. A motor for selection is necessitated to result in enlarging a size of the analyzer body. The use of the lamp has a drawback in requirement of long time for stabilizing temperature due to a great amount of heat, and a drawback of much power required for illumination.

JP-A 2004-226262 discloses a biochemical analyzer in which light-emitting diodes (LEDs) are used for a light source in an optical assay. As an LED is characterized in emitting light of a component with only a limited wavelength, and is advantageous in no requirement of the above-described interference filter, and low levels of electric power and heat in comparison with a lamp. It is conceivable to arrange plural LEDs on a light surface base surface, and drive a selected one of the LEDs with a wavelength only associated with a reagent. It is possible to assay plural biomaterials to be measured.

In the known analyzer, the light source in the optical assay unit is tilted at an angle of 45° with respect to the assay surface of an analysis slide. A photoreceptor is directed to the assay surface, and measures scattered light traveling in a direction along a normal line of the assay surface. There occurs a problem in that reflected light of a regular reflection on the assay surface strikes, and reflected by, an LED of a supporting mechanism for the LED to create stray light. Precision in the measurement is likely to low as the stray light is likely to travel to the photoreceptor.

### SUMMARY OF THE INVENTION

In view of the foregoing problems, an object of the present invention is to provide a light measuring device for use in a biochemical analyzer, which can be constructed with portability, and in which light can be measured with high precision, and also a biochemical analyzer, a biochemical analysis method, and a spectrophotometer.

In order to achieve the above and other objects and advantages of this invention, a light measuring device for light measurement by use of an assay surface and at least one light source is provided, the assay surface being provided with a sample positioned thereon, the light source being oriented to tilt at a predetermined angle with respect to the assay surface, for applying illuminating light to the assay surface. The light measuring device includes a photoreceptor, positioned in a light path extending from the assay surface, for measuring scattered reflected light of diffuse reflection from the assay surface. A light absorber is positioned in a light path of the illuminating light emitted by the light source and reflected in regular reflection by the assay surface, for absorbing the illuminating light.

The light absorber includes a light absorbing surface having a color of a high density and a low gloss.

Furthermore, an aperture is positioned between the assay surface and the photoreceptor, for passage of the scattered reflected light in a predetermined region.

Furthermore, a controller turns on and off the light source. The photoreceptor responds to turning on of the light source, to output a signal of the scattered reflected light.

The at least one light source comprises plural light sources, the at least one light absorber comprises plural light absorbers, the plural light sources and the plural light absorbers are arranged on a circle concentrically about the assay surface.

The plural light sources are arranged in one light source train, and the plural light absorbers are arranged in one light absorber train.

The at least one light source comprises plural light sources, arranged on a circle concentrically about the assay surface, for light emission at wavelengths different from one another.

Each of the plural light sources includes at least one light-emitting diode.

The light absorber is in a tubular shape, has a first end open toward the assay surface, has a second end being closed, has a black colored inner surface, for trapping the illuminating light from the assay surface.

The predetermined angle is 30-60 degrees.

A biochemical analyzer includes a light source for illuminating an assay surface oriented to tilt at a predetermined angle. A photoreceptor is positioned in a light path extending from the assay surface, for measuring scattered reflected light of diffuse reflection from the assay surface where a fluid sample is dropped. A quantitative analysis unit quantitatively analyzes the sample according a measuring result of the scattered reflected light. A light absorber is positioned in a light path in regular reflection by the assay surface illuminated in the light emission of the light source.

The assay surface comprises an analysis slide where the sample is dropped.

A spectrophotometer for optically assaying a sample by use of an assay surface and a light source is provided, the assay surface being provided with the sample positioned thereon, the light source applying illuminating light to the assay surface. The spectrophotometer includes a spectroscopic device for spectroscopically separating the illuminating light from the assay surface. A photoreceptor constitutes an optical assay unit of multi-channel spectroscopic measurement, and for detecting the illuminating light from the spectroscopic device per a specific wavelength, to obtain a detection signal. An arithmetic processor processes the detection signal from the photoreceptor by weighting with weight information, to obtain a corrected detection signal associated with the specific wavelength, the weight information being associated with respectively plural specific wavelengths, the corrected detection signal being used for analysis of the sample.

The weight information is determined according to a characteristic difference between the multi-channel spectroscopic measurement and optical band-pass filter measurement for the plural specific wavelengths. In the analysis of the sample, measured data of the sample is obtained from the corrected detection signal by referring to a calibration curve of the optical band-pass filter measurement.

The photoreceptor comprises a photoreceptor array of plural photoreceptors, arranged in a wavelength distribution direction of the spectroscopic device, for detecting the illuminating light from the spectroscopic device for respectively the specific wavelength.

The spectroscopic device comprises diffraction gratings.

Furthermore, an A/D converter converts the detection signal into photoelectric data in a digital form, to output the detection signal to the arithmetic processor.

In a preferred embodiment, the arithmetic processor includes an amplifier for amplifying the detection signal at an amplification factor associated with respectively the specific wavelengths. An adder adds up the detection signal being amplified.

In another preferred embodiment, the arithmetic processor includes a transmittance distribution optical filter, disposed in a light path of the illuminating light between the spectroscopic device and the photoreceptor, and changeable in transmittance in a wavelength distribution direction. An adder adds up the detection signal output by the photoreceptor.

An analysis slide is loadable, for constituting the assay surface, wherein the sample reflects the illuminating light with the assay surface, for traveling to the spectroscopic device.

In still another preferred embodiment, a sample vessel is loadable, and includes a transparent portion for constituting the assay surface, and contains the sample, wherein the sample and the transparent portion transmit the illuminating light to travel to the spectroscopic device.

The photoreceptor comprises a photo diode.

A biochemical analyzer for optically assaying a sample by use of illuminating light, to analyze the sample, is provided. A light source applies the illuminating light to an assay surface where the sample is positioned. A spectroscopic device spectroscopically separates the illuminating light from the assay surface. A photoreceptor constitutes an optical assay unit of multi-channel spectroscopic measurement, and detects the illuminating light from the spectroscopic device per a specific wavelength, to obtain a detection signal. An arithmetic processor processes the detection signal from the photoreceptor by weighting with weight information, to obtain a corrected detection signal associated with the specific wavelength, the weight information being associated with respectively plural specific wavelengths, the corrected detection signal being used for analysis of the sample.

Furthermore, a data storage stores information of a calibration curve of optical band-pass filter measurement and weight information of weighting and correction with respect to the plural specific wavelengths, the weight information being determined according to a characteristic difference between the multi-channel spectroscopic measurement and the optical band-pass filter measurement. A quantitative analysis unit obtains measured data of the sample from the corrected detection signal by referring to the calibration curve of the optical band-pass filter measurement.

The photoreceptor comprises a photoreceptor array of plural photoreceptors, arranged in a wavelength distribution direction of the spectroscopic device, for detecting the illuminating light from the spectroscopic device for respectively the specific wavelength.

The spectroscopic device comprises diffraction gratings.

In a biochemical analysis method, illuminating light is applied to a sample. The illuminating light traveling from the sample is spectroscopically separated. The illuminating light being separated is detected per a specific wavelength. A detection signal of the illuminating light is processed per the specific wavelength by weighting with weight information, to obtain a corrected detection signal for the specific wavelength.

The detection signal is obtained by multi-channel spectroscopic measurement, and the weight information is determined according to a characteristic difference between the multi-channel spectroscopic measurement and optical band-pass filter measurement. Furthermore, information of a calibration curve of the optical band-pass filter measurement is stored. Measured data of the sample is obtained from the corrected detection signal by referring to the calibration curve of the optical band-pass filter measurement.

A biochemical analyzer includes a light source for applying illuminating light to an assay surface provided with a sample positioned thereon, and an optical assay unit for quantitatively analyzing the sample by receiving the illuminating light from the assay surface. In the biochemical analyzer, the light source includes a white light-emitting element for emitting a white component of the illuminating light. At least one additional light-emitting element emits a color component of the illuminating light and at a predetermined wavelength, to compensate for shortage of light of the color component.

The white light-emitting element and the at least one additional light-emitting element are respectively light-emitting diodes.

At least one additional light-emitting element comprises a first additional light-emitting element of which the predetermined wavelength is 460 nm or less. There is a second additional light-emitting element of which the predetermined wavelength is equal to or near to 505 nm.

The white light-emitting element, the first and second additional light-emitting elements are arranged triangularly.

In a preferred embodiment, the white light-emitting element is disposed between the first and second additional light-emitting elements.

Furthermore, at least one optical filter is disposed in a light path of the illuminating light from the light source to the optical assay unit, and having a wavelength selectivity for a specific wavelength band.

At least one optical filter comprises plural optical filters of which the specific wavelength band is different from one another. Furthermore, a filter selector sets a selected one of the plural optical filters in the light path.

The filter selector includes a rotatable filter turret, partially disposed in the light path, for supporting the plural optical filters arranged on a circle concentrically about a pivotal axis thereof. A motor rotates the filter turret.

### BRIEF DESCRIPTION OF THE DRAWINGS

The above objects and advantages of the present invention will become more apparent from the following detailed description when read in connection with the accompanying drawings, in which:

FIG. 1A is a perspective view illustrating a biochemical analyzer;

FIG. 1B is a perspective view illustrating the preferred biochemical analyzer in an open position;

FIG. 2 is a vertical section illustrating a light reflecting device in the biochemical analyzer;

FIG. 3 is a plan illustrating the biochemical analyzer;

FIG. 4 is a plan illustrating other preferred arrangement of an LED and a light absorber;

FIG. 5 is a vertical section illustrating a state of a transfer tray in a second position;

FIG. 6 is a vertical section illustrating a state of a reference white region in an assay position;

FIG. 7 is a vertical section illustrating another preferred embodiment with a light absorber in a tubular shape;

FIG. 8A is a perspective view illustrating one preferred biochemical analyzer;

FIG. 8B is a perspective view illustrating the preferred biochemical analyzer in an open position;

FIG. 9 is a perspective view illustrating an analysis slide for sample;

FIG. 10 is a block diagram illustrating a spectrophotometer;

FIG. 11A is a graph illustrating reflectance of the sample;

FIG. 11B is a graph illustrating photoelectric data obtained from the sample;

FIG. 12A is a graph illustrating optical transmittance and a wavelength;

FIG. 12B is a graph illustrating weight information and the wavelength;

FIG. 13 is a flow chart illustrating measurement of reflectance;

FIG. 14 is a block diagram schematically illustrating a spectrophotometer;

FIG. 15 is an explanatory view illustrating another preferred spectrophotometer in which an amplification factor is changeable;

FIG. 16 is a graph illustrating the amplification factor and the wavelength;

FIG. 17 is an explanatory view illustrating a preferred spectrophotometer with a use of a transmittance distribution filter;

FIG. 18 is a graph illustrating transmittance and photo diode locations;

FIG. 19 is a perspective view illustrating another preferred embodiment of a lower cover and a transfer tray;

FIG. 20A is a plan illustrating a state of the same as FIG. 19 in an initial set position;

FIG. 20B is a plan illustrating a state of the same as FIG. 19 in an open position;

FIG. 21 is a vertical section illustrating an optical assay unit;

FIG. 22A is a cross section illustrating an LED unit;

FIG. 22B is a vertical section illustrating the LED unit;

FIG. 23 is a graph illustrating wavelength bands of light emitted by the LED unit;

FIG. 24A is a graph illustrating a wavelength bands of a white light component;

FIG. 24B is a graph illustrating the wavelength bands of the three color light components;

FIG. 25 is a plan illustrating a filter turret;

FIG. 26A is a graph illustrating wavelength bands of light transmissible through first and third band-pass filters;

FIG. 26B is a graph illustrating wavelength bands of light transmitted through the first and third band-pass filters;

FIG. 27 is a block diagram schematically illustrating circuitry in the biochemical analyzer;

FIG. 28 is a flow chart illustrating a flow of the biochemical analysis;

FIG. 29 is a cross section illustrating another preferred LED unit in which the LEDs are collinear.

### DETAILED DESCRIPTION OF THE PREFERRED EMBODIMENT(S) OF THE PRESENT INVENTION

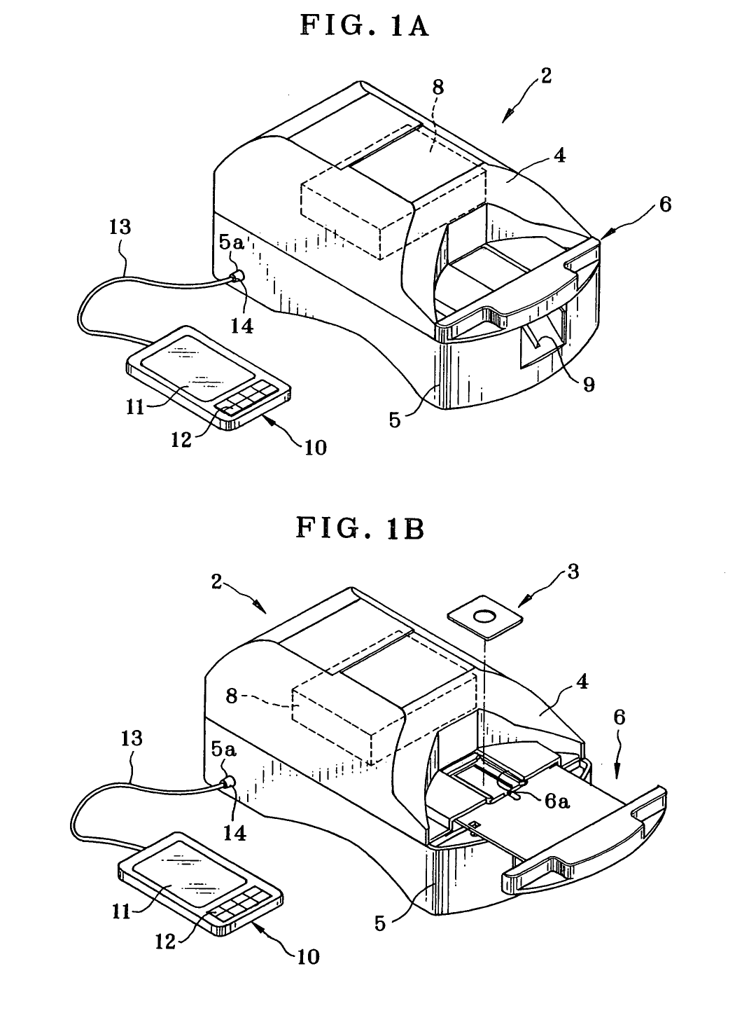

In FIGS. 1A and 1B, a biochemical analyzer 2 of a portable type is illustrated. A sample slide or analysis slide 3 having an assay surface is set in the biochemical analyzer 2 for assay of blood, urine or other fluid samples by quantitative analysis. The biochemical analyzer 2 includes an upper cover 4, a lower cover 5 and a transfer tray or sample holder 6.

An incubator 8 is contained inside the upper cover 4. The incubator 8 has elements including a heater, and incubates the analysis slide 3 by maintenance at a constant temperature for a prescribed time. An exit channel 9 is formed in a front face of the lower cover 5 for exiting the analysis slide 3 being assayed. A connection interface 5a is positioned in a lateral face of the lower cover 5. A terminal device 10 as user interface in a quantitative analysis unit is electrically connected with the biochemical analyzer 2 by the connection interface 5a.

An example of the terminal device 10 is a PDA (Personal Digital Assistant) of a general-purpose type. Programs for analysis are installed by means of a memory card or the like. When each of the programs is started up, the terminal device 10 can operate for the analysis according to relevant items of processing. The terminal device 10 includes an LCD display panel 11 and a keypad 12. A plug 14 of a connection line 13 is inserted in the connection interface 5a for connecting the terminal device 10 with the biochemical analyzer 2. The LCD display panel 11 displays a message for encouraging a user to operate, information of results of analyzing the sample in the analysis slide 3, and the like. A user operates the keypad 12 by viewing the LCD display panel 11.

An inner power source is contained in a space of the lower cover 5. An example of the inner power source is four batteries of the type AA. Circuits are supplied with power by the inner power source, including the incubator 8, a photometric unit or optical assay unit 20 and the like.

A slide holder opening 6a is formed in the transfer tray 6 for setting the analysis slide 3 therein. The transfer tray 6 is kept movable in forward and backward directions, and transfers the analysis slide 3 to the inside of the biochemical analyzer 2. In FIG. 1A, the biochemical analyzer 2 is illustrated in a state where the transfer tray 6 is in a measuring position for assay of the analysis slide 3. In FIG. 1B, the biochemical analyzer 2 is illustrated in a state where the transfer tray 6 is in an initial set position for setting of the analysis slide 3 in front of the measuring position. There is an exit position (not shown) where the transfer tray 6 is set and which is offset in the forward direction from the initial set position. The transfer tray 6 moves between the measuring and exit positions. When the transfer tray 6 is in the exit position, the analysis slide 3 is caused to drop from the slide holder opening 6a, and exited through the exit channel 9.

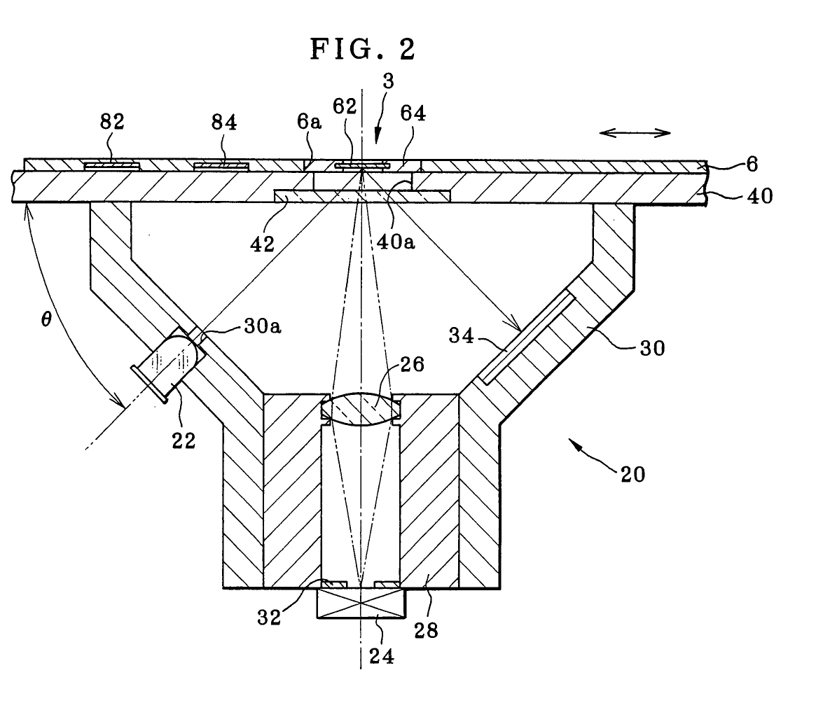

In FIG. 2, the optical assay unit 20 and other elements in the biochemical analyzer 2 are schematically illustrated. The optical assay unit 20 is incorporated in a space within the lower cover 5, and positioned directly lower than the incubator 8 on a side of the transfer tray 6. The optical assay unit 20 includes an LED light source or illuminator 22, a photoreceptor or photo diode 24, a condenser lens 26, a lens barrel 28 and an analysis barrel 30. The LED light source 22 has such a light path directed with an inclination of an angle θ equal to 45 degrees. The photo diode 24 converts received light into a signal photoelectrically. The condenser lens 26 condenses light and focuses the light on a plane which is on the photo diode 24. The lens barrel 28 has the condenser lens 26 mounted therein. The analysis barrel 30 supports those various elements.

A base board 40 is disposed on the optical assay unit 20 for supporting the transfer tray 6. An aperture 40a is formed in the base board 40, positioned at the photoreceptor or photo diode 24 in a photometric position, for passage of light emitted by the LED light source 22. A glass protector 42 of transparent glass is fitted in the aperture 40a, and protects entry of dust into the optical assay unit 20.

Rails (not shown) are formed on the base board 40, extend sufficiently for movement of the transfer tray 6 between the measuring position and initial set position, and support the analysis slide 3 fitted on the slide holder opening 6a. When the transfer tray 6 is shifted to the exit position, the analysis slide 3 is caused to drop out of the slide holder opening 6a owing to a position short of the rails on the base board 40.

A reference white region 82 and a reference black region 84 or white and black plates are disposed on the transfer tray 6, directed toward the optical assay unit 20, and adapted to measuring reference density. When the transfer tray 6 moves from the initial set position to the measuring position, the reference regions 82 and 84 are measured.

The analysis slide 3 is constituted by a multi-layer film 62 and a slide frame 64. The multi-layer film 62 of a dry form is a laminate of a support, a reagent layer and a developing layer. The slide frame 64 supports the multi-layer film 62. A circular hole is formed in an upper panel of the slide frame 64 for spotting a fluid sample such as blood, urine and the like. See FIG. 1B. An optical assay hole is formed in a lower panel of the slide frame 64 for measuring optical density of visible color of the multi-layer film 62 in color reaction in a visible manner. A surface of the multi-layer film 62 uncovered through the circular hole is an assay surface. Both of the reference regions 82 and 84 are positioned flush with the assay surface. The term of the assay surface is hereinafter used also to refer to the reference regions 82 and 84.

Sensors (not shown) are arranged on the base board 40 for detecting setting of the analysis slide 3, the reference regions 82 and 84 in the detection position. Upon the detection, the optical assay unit 20 causes the LED light source 22 to emit light for a short time, for example 200 msec.

The photoreceptor or photo diode 24 receives scattered light of the diffuse reflection reflected vertically by the assay surface and photoelectrically converts the light when the LED light source 22 emits light to the assay surface in the detection position. Light emitted by the LED light source 22 is likely also to travel toward the slide frame 64, the transfer tray 6 or other elements. In view of this, an aperture 32 is disposed in front of the photo diode 24 for limiting reception of light for the scattered light of the diffuse reflection from the assay surface. Also, an aperture 30a is formed in a front panel at the LED light source 22 for suppressing surplus scattering of illuminating light.

Light emitted by the LED light source 22 and reflected by the regular reflection travels to and becomes incident on the inner surface of the analysis barrel 30. If the regularly reflected light is further reflected, stray light occurs and travels to the photo diode 24, and is likely to lower precision in the measurement. In view of this problem, a light absorber 34 in a flat form is attached to the inner surface of the analysis barrel 30. A surface of the light absorber 34 is finished by the black matte finish. Any suitable material may be used for the light absorber 34, for example a black panel with a surface having a fine pattern of projections or recesses, a black panel of resin with a surface finished in a non-gloss manner. The light absorber 34 may not be a panel. For example, a sticker or label can be attached. Such a light absorbing region should be larger than a spot region of regular reflection of light incident to the inner surface of the analysis barrel 30. A recessed structure disclosed in U.S. Pat. No. 5,611,999 (corresponding to JP-A 9-145615) can be used, in which the recessed structure in a tubular shape has an inner fine pattern of parallel grooves.

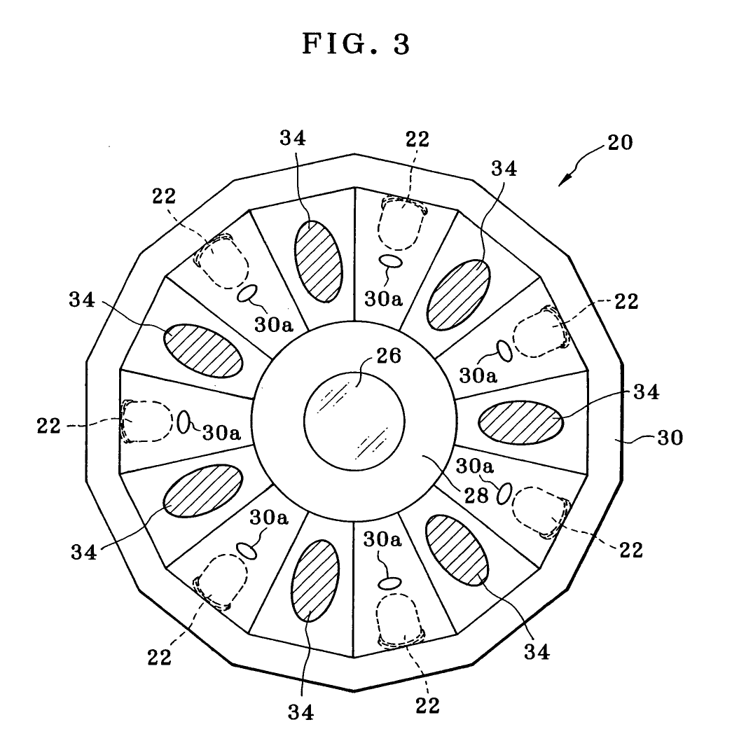

In FIG. 3, the optical assay unit 20 is viewed on its top. The LED light source 22 and the light absorber 34 are grouped in seven (7) pairs, and arranged on a circle concentrically about a center that is defined by the assay surface for the detection position. Light which can be emitted by the LED light sources 22 has a wavelength different between those. A selected one of the LED light sources 22 with a wavelength associated with reagent on the analysis slide 3 is driven to emit light. Thus, any of target biomaterials can be assayed readily. In the present embodiment, seven LEDs 22 are used in a compatible manner for all of 27 items of measurement for glucose or other biomaterials in a large-scale biochemical analyzer, and emit light of wavelengths of 400, 505, 540, 570, 600, 625 and 650 nm. Note that wavelengths associated with the LED light sources 22 can be differently determined. The number of the LED light sources 22 may be six or less, or may be eight or more.

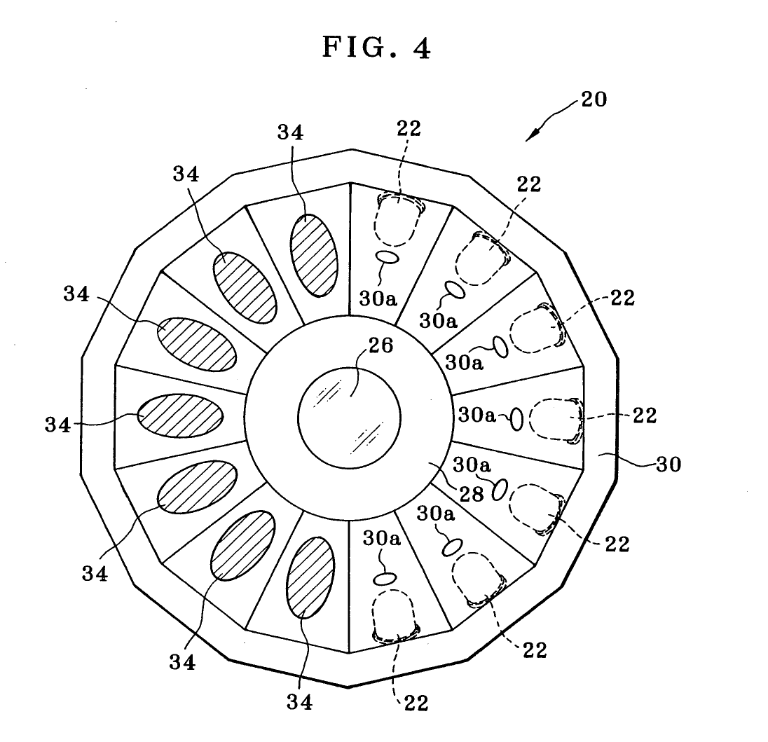

In FIG. 4, another preferred disposition of the LED light source 22 and the light absorber 34 is illustrated. A first half of a circle has a series of the LED light sources 22 and the aperture 30a. A second half of the circle has a series of the light absorber 34 in a grouped manner of FIG. 4. This makes it possible to receive light of regular reflection in adjacent two of the light absorber 34. Prevention of increase of stray light from the regular reflection light is more effective.

Furthermore, it is preferable to manage the temperature at an adjusted unchanged level because the wavelength of the LED light source 22 is changeable according to temperature. To this end, a Peltier element can be added to the analysis barrel 30 to support the LED light source 22. Also, a heater in the incubator 8 can be used instead of additional adjuster for the temperature. The heater in the incubator 8 can adjust the temperature of the LED light source 22 at a constant level, for example 37° C.

The operation of the biochemical analyzer 2 constructed above is described now with an example of glucose in blood as target biomaterial.

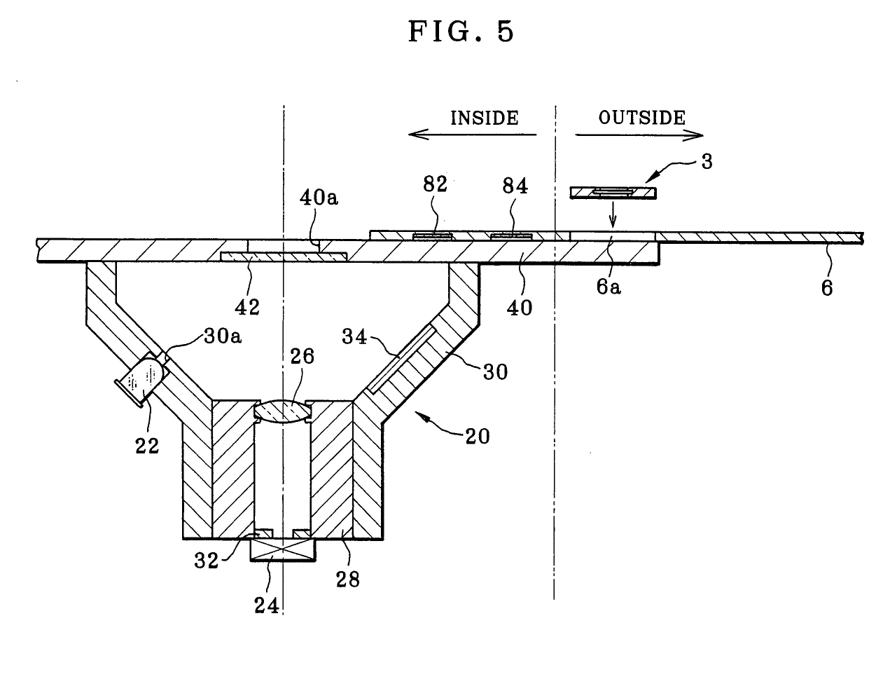

At first, the analysis slide 3 is set in the slide holder opening 6a of the transfer tray 6 which is in the initial set position. See FIG. 5. A user or operator operates the keypad 12 in the terminal device 10, and sends information of glucose to the biochemical analyzer 2 as he or she designates glucose as target biomaterial to be assayed. While the analysis slide 3 is set in the slide holder opening 6a, a prescribed amount of human blood, which is fresh blood and drawn with heparin, is dropped down to the multi-layer film 62 through the circular hole in the analysis slide 3. An example of the prescribed amount is 10 microliters.

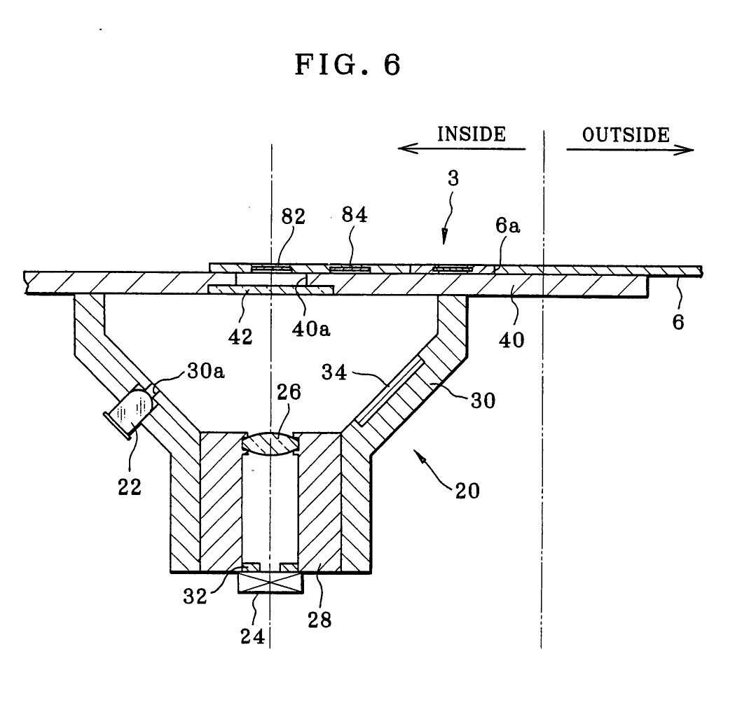

After dropping the sample, the transfer tray 6 is moved from the initial set position to the measuring position. In FIG. 6, the reference white region 82 reaches the detection position. In the optical assay unit 20, a sensor on the base board 40 detects the reference white region 82, so that one of the LED light source 22 with the wavelength of 505 nm is driven, 505 nm corresponding to glucose. Note that driving of the LED light source 22 is allowed only when the assay surface is set at the detection position. This prevents the LED light source 22 from surplus emission. The wavelength in the emitted light can be prevented from changing due to a change in the temperature, because surplus heating of the LED light source 22 is prevented.

The photoreceptor or photo diode 24 photoelectrically converts received scattered light of the diffuse reflection from the reference white region 82 in the direction vertical to its assay surface. A processor (not shown) is provided with information of a reference density as a result of measuring the reference white region 82. The light absorber 34 absorbs the light of the regular reflection of the assay surface and the glass protector 42. It is thus possible to prevent entry of stray light derived from the regularly reflected light to the photo diode 24, and to prevent precision from being low in the measurement.

The transfer tray 6 is further moved to the measuring position to set the reference black region 84 in the detection position. Then the optical assay unit 20 measures the reference density of the reference black region 84 in the manner similar to the above, and sends density information to the processor.

A sensor on the base board 40 detects the reach of the transfer tray 6 to the measuring position of FIG. 2. Then the incubator 8 is driven to incubate the analysis slide 3 at 37° C. for one (1) minute. Note that the reagent layer in the analysis slide 3 is pre-associated with glucose. The incubation causes color reaction of the reagent layer at optical density according to the content of glucose contained in the fluid sample.

The optical assay unit 20 operates after completion of the incubation, and measures optical density of color of the analysis slide 3, and sends information of the measured density to the processor. Note that the incubation with the incubator 8 can be different from the above within a sequential operation. For example, the analysis slide 3 can be preliminarily subjected to the incubation, and then set at the slide holder opening 6a. After this, measurement of the reference white region 82, the reference black region 84 and the analysis slide 3 can be made directly after one another.

The processor calculates the content of glucose in the sample according to the measured results. The analysis slide 3 is caused to drop through the slide holder opening 6a by shifting the transfer tray 6 to the exit position, and is exited at the exit channel 9. The substance or biomaterial as sample according to the above embodiment is glucose. Note that approximately 27 types of analytes can be assayed by the biochemical analyzer 2 suitably combining a wavelength used in the biochemical analyzer 2 and a reagent layer in the analysis slide 3. For example, amylase can be tested with a wavelength of 400 nm. Creatinine can be tested with a wavelength of 600 nm.

As a result, the light absorber 34 is positioned to receive regular reflection of light emitted by the LED light source 22 and reflected by the assay surface. Assay with high precision is possible in the optical assay unit 20. Also, the LED light source 22 is driven for emission each time that the assay surface is set at the detection position. Thus, the rise of the temperature of the LED light source 22 is minimized. It is possible to suppress drop in the precision due to changes in the wavelength of light of the LED light source 22 with temperature.

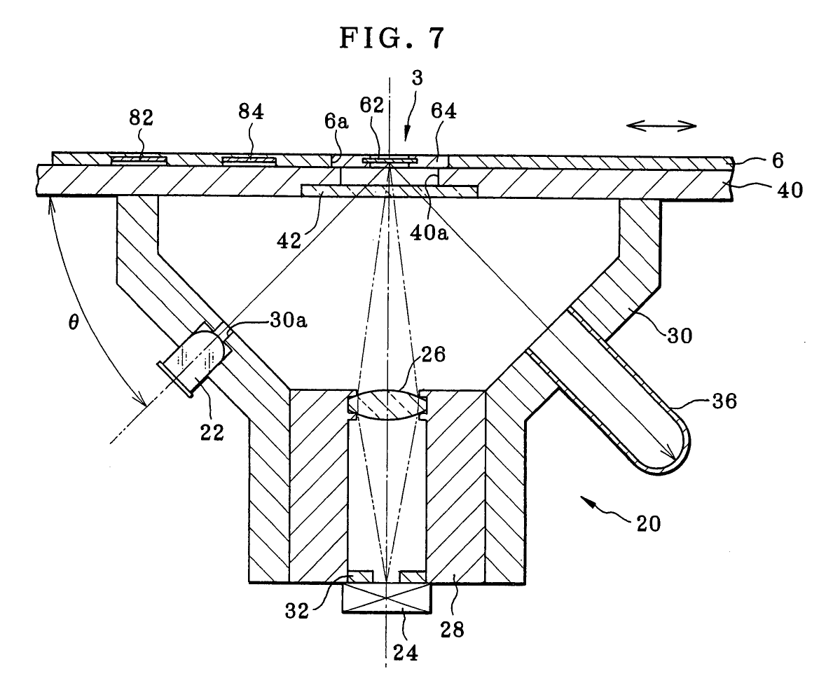

In FIG. 7, the use of another preferred light absorber is illustrated. A light trap 36 or tube of a labyrinth has a first end which is closed, and a second end open to the inside of the analysis barrel 30. The entirety of an inner surface of the light trap 36 is finished by the black matte finish. It is not possible in the light absorber 34 to absorb a light component having been reflected on the light absorber 34, because the light absorber 34 has a simple panel shape for reception of light. In contrast with this, the light trap 36 has a possibility in that a light component after reflection of two or more times will be trapped because of the tubular shape. Consequently, prevention of precision from dropping in the assay can be reliable by use of the light trap 36.

If a diameter of a light spot of the regularly reflected light traveling to the analysis barrel 30 is considerable great, it is possible to color the inner surface of the analysis barrel 30 with a black color by black matte finish or the like. In the above embodiment, the inner surface of the analysis barrel 30 has a shape of a frustum of a tetradecagonal pyramid with 14 facets. However, the inner surface may have a shape of a frustum of a cone.

Note that the angle θ defined between the assay surface and the path of incident light from the LED light source 22 to the assay surface may be any value other than 45 degrees of the above embodiment. However, the LED light source 22 can be preferably positioned on the analysis barrel 30 to satisfy a condition of the angle θ in a range of 30-60° in consideration of scattered light of the diffuse reflection in the normal line direction toward the photoreceptor or photo diode 24.

In the above embodiment, a light measuring device for measuring reflected light is used in a biochemical analyzer. However, a light measuring device of the invention can be used in any of various apparatuses, for example, a colorimeter of a type of single-direction illuminating system, spectrophotometric calorimeter, and the like.

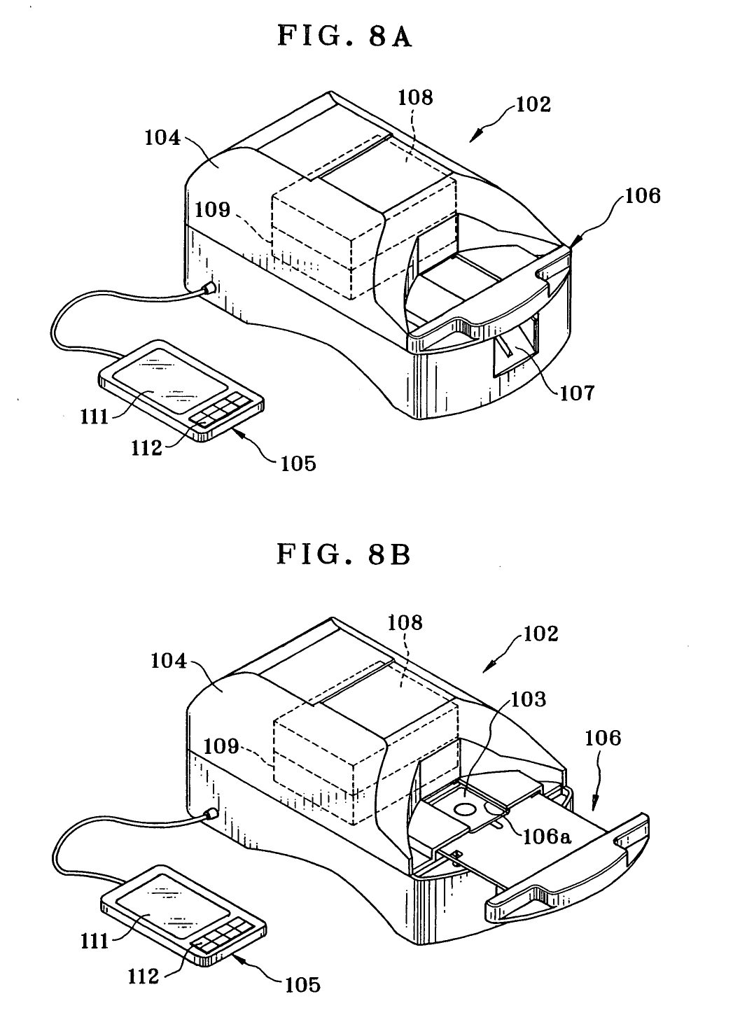

Another preferred embodiment is described now with reference to FIGS. 8A-18. In spite of various suggestions of optical methods of biochemical analysis according to documents including U.S. Pat. No. 4,823,169 (corresponding to JP-A 62-198736 and JP-B 5-072976), JP-A 64-018047 and JP-A 2003-139611, there has been a drawback inconsistent to simplification of relevant devices. In measuring optical density with respect to light at the same specific wavelength, measured data of optical band-pass filter measurement according to JP-A 64-018047 is not equivalent to the measured data of a multi-channel spectroscopic measurement. With respect to the multi-channel spectroscopic measurement, the measured data is a result of reception of light of a component with a very narrow bandwidth defined about the specific wavelength to be assayed. In contrast, with respect to the band-pass filter measurement, an optical band-pass filter allows passage of a somewhat large bandwidth defined about the specific wavelength. Also, there is a characteristic of the band-pass filter in that its transmittance is gradually decreased in sections before and after the specific wavelength. The measured data being obtained is based on the reception with a photo diode for the passed light with this somewhat large bandwidth. Due to this lack of the equivalence in the measured data, a calibration curve between the optical density and the content of a target biomaterial in compliance with the band-pass filter measurement cannot be utilized for the measured data according to the multi-channel spectroscopic measurement. If the system of the measurement is changed, a new form of the calibration curve must be created.

In FIGS. 8A and 8B, a biochemical analyzer 102 of a portable type to solve this problem is illustrated. The biochemical analyzer 102 is a quantitative analysis unit for use with a sample slide or analysis slide 103 having an assay surface, and assays the sample in the analysis slide 103 quantitatively in a form of density data of the content of a biomaterial contained in the sample or solid content in the same. The biochemical analyzer 102 includes an analyzer body 104 and a terminal device 105 as user interface.

A transfer tray or sample holder 106 is disposed in the analyzer body 104 for supporting the analysis slide 103 to transfer. In FIG. 8B, an initial set position of the transfer tray 106 is depicted. The transfer tray 106 is movable between a measuring position and an exit position, and when in the measuring position of FIG. 8A, kept pushed inside the analyzer body 104 and interior from the initial set position, and when in the exit position, shifted outward from the initial set position. At the time of the assay, the transfer tray 106 is shifted in the initial set position. A slide holder opening 106a in the transfer tray 106 is provided with the analysis slide 103 to be assayed, before the transfer tray 106 is shifted to the measuring position. After the assay, the transfer tray 106 is drawn to the exit position, to cause the analysis slide 103 to drop down through an exit channel 107 from the slide holder opening 106a for exiting.

An incubator 108 and a spectrophotometer 109 are incorporated in the analyzer body 104. At the time of the assay, the incubator 108 maintains the analysis slide 103 at a constant temperature for a prescribed time. The spectrophotometer 109 measures reflectance at a specific wavelength that is associated with the content to be assayed. The reflectance is output as measured data. Note that the measured data is equivalent to reflectance according to measurement with a band-pass filter.

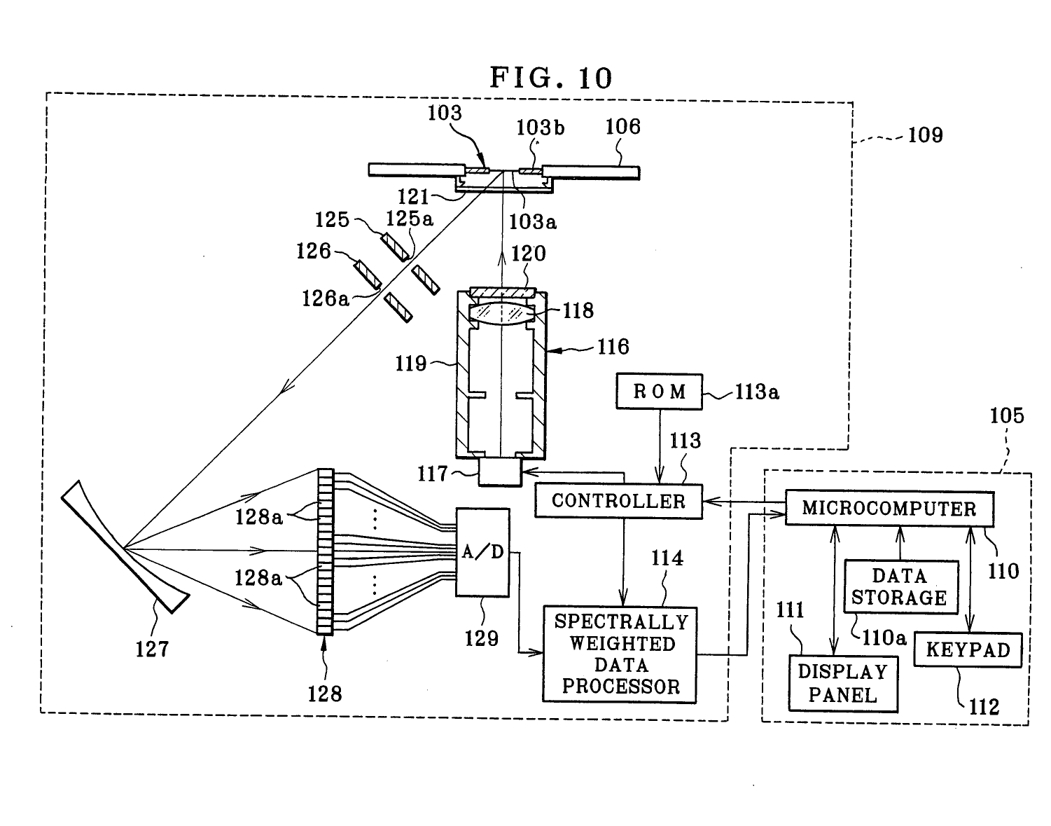

The terminal device 105 is connected with the analyzer body 104 by a connection line. An example of the terminal device 105 is a PDA (Personal Digital Assistant) of a general-purpose type. Programs are installed by means of a memory card or the like, and include a system managing program for combining operation with the analyzer body 104, a density converting program for converting measured data from the spectrophotometer 109 to content of the target biomaterial, and the like. A microcomputer 110 in the quantitative analysis unit of FIG. 10 is incorporated in the terminal device 105, and executes the programs. The terminal device 105 includes an LCD display panel 111 and a keypad 112. The LCD display panel 111 displays a message for encouraging a user to operate, information of results of analyzing the sample in the analysis slide 103, and the like. A user operates the keypad 112 by viewing the LCD display panel 111, and inputs a setting to designate one of target biomaterials.

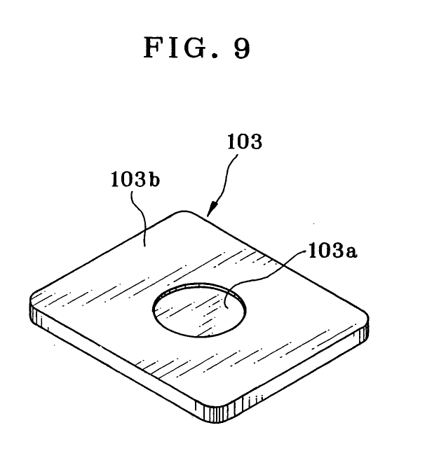

In FIG. 9, the analysis slide 103 includes a multi-layer film 103a and a slide frame 103b for supporting the multi-layer film 103a. The multi-layer film 103a is a laminate of a transparent support, a reagent layer of reaction, a reflection layer, and a developing layer. A circular hole is formed in an upper panel of the slide frame 103b for spotting a fluid sample on a developing layer. See FIG. 1B. An optical assay hole is formed in a lower panel of the slide frame 103b on the transparent support. The sample is dropped on the developing layer. For the assay, the reagent layer of reaction is viewed through the support. The sample is spread uniformly on the developing layer, penetrates through the reflection layer, and reaches the reagent layer of reaction. The reagent layer of reaction contains dry reagent, which reacts on the sample to develop visible color. Examples of fluid samples are whole blood, serum, blood plasma, urine and the like.

In FIG. 10, the spectrophotometer 109 and the terminal device 105 are illustrated. A controller 113 controls elements included in the spectrophotometer 109, and measures reflectance with respect to a specific wavelength according to a target biomaterial designated by the terminal device 105. Also, the controller 113 controls the incubator 108 according to a position of the transfer tray 106, and maintains the analysis slide 103 at a constant temperature for a prescribed time. A ROM 113a initially stores data of weights for specific wavelengths at which reflectance is measured.

A spectrally weighted data processor 114 as an arithmetic processor is controlled by the controller 113. When a target biomaterial is designated with the microcomputer 110, the controller 113 sets a specific wavelength in the spectrally weighted data processor 114 according to the target biomaterial. The spectrally weighted data processor 114, performing digital calculation according to a program, is responsive to reception of photoelectric data and data of weights determined by the controller 113, and obtains measured data that is equivalent to those according to the band-pass filter measurement of the prior art. The measured data is output to the microcomputer 110.

An illuminator 116 includes a white light source 117, a condenser lens 118, a lens barrel 119 and a transparent heat insulating panel or filter 120. The analysis slide 103 is set on the transfer tray 106 in an orientation with its support directed to the illuminator 116. Illuminating light from the illuminator 116 is controlled by the condenser lens 118 for a suitably adjusted diameter of flux, and travels to the surface of the multi-layer film 103a at an angle of incidence of zero (0) degree. The heat insulating panel 120. cuts heat from the illuminator 116, and prevent rise of temperature of the analysis slide 103. A glass protector 121 is disposed between the illuminator 116 and the analysis slide 103 for preventing entry of dust.

There are slit-formed panels 125 and 126 and concave diffraction gratings 127 as diffractor arranged on a path of light exiting from the multi-layer film 103a, the path extending at an angle of 45 degrees with respect to a normal line of the surface of the multi-layer film 103a. A slit 125a is formed in the slit-formed panel 125, a slit 126a in the slit-formed panel 126. The concave diffraction gratings 127 for spectroscopy receive scattered light reflected by diffuse reflection of the multi-layer film 103a and passed through the slits 125a and 126a. In the concave diffraction gratings 127 are formed a great number of grooves parallel with one another at a regular interval, to separate and reflect the scattered illuminating light.

Note that an aperture stop opening may be used in place of each of the slits 125a and 126a. Furthermore, an angle of incidence of the illuminating light to the multi-layer film 103a can be any suitable value in place of 0 (zero) degree of the above embodiment. An angle of scattering of the light from the multi-layer film 103a can be any suitable value in place of 45 degrees. Any suitable types of spectroscopes may used, including a dispersive spectrometer for spectroscopy unlike the interference spectrometer.

There is a photoreceptor array or photo diode array 128 upon which illuminating light separated by the concave diffraction gratings 127 becomes incident. A great number of photoreceptors or photo diodes 128a are arranged in the photoreceptor array 128 in a direction of dispersion of the illuminating light. The photo diodes 128a are arranged on a focal plane of an optical system where spectra of the illuminating light are focused. The photoreceptor array 128 includes the photo diodes 128a arranged at a small regular pitch which is smaller than intervals between positions of specific wavelengths for assay. The illuminating light separated by the concave diffraction gratings 127 is received and sampled by the photo diodes 128a for each of the wavelengths. The photo diodes 128a output a detection signal photoelectrically according to intensity of the received light.

It is possible to use a CCD line sensor or the like as a photoreceptor array. Furthermore, it is possible to slide a single photoreceptor in a dispersing direction of the illuminating light, and to sample the detection signal from the photoreceptor in synchronism with the sliding. In addition, a rotatable structure of U.S. Pat. No. 5,923,420 (corresponding to JP-A 10-332484) can be used, in which the concave diffraction gratings 127 are rotationally movable by use of a motor, in combination with a single photo diode or photoreceptor.

An A/D converter 129 receives a detection signal from the photoreceptors or photo diodes 128a, and converts the same into photoelectric data. The photoelectric data is information of reflectance of a surface of the multi-layer film 103a at a corresponding one of the wavelengths.

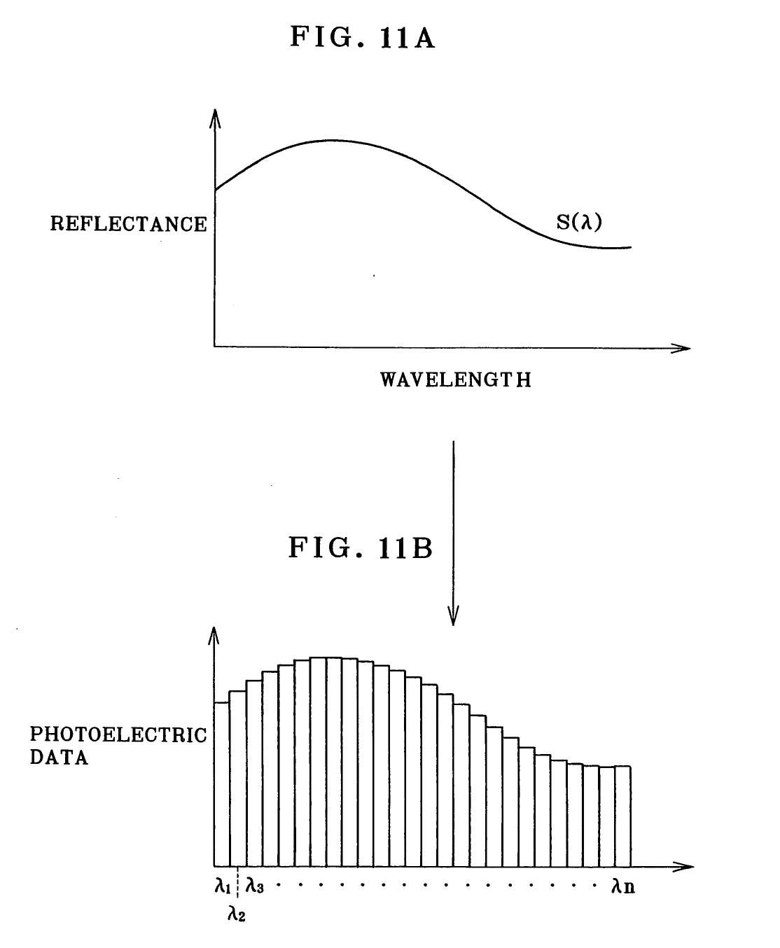

The illuminating light, when reflected, is separated by the concave diffraction gratings 127 and received by the photo diodes 128a. So reflectance S(λ) as a function of the wavelength λ, as depicted in FIG. 11A, is converted into n sets of photoelectric data associated with wavelengths λ₁, λ₂, . . . , λₙ of FIG. 11B. It is to be noted that, strictly speaking, the wavelength λᵢ where i is 1, 2, . . . , n is used to refer to a wavelength band with a bandwidth according to a width of the photo diodes 128a.

The data of weights are determined according to transmittances of optical band-pass filters used in the band-pass filter measurement known in the art. For one specific wavelength, n sets of data of weights are determined for each wavelength λᵢ where i is 1, 2, . . . , n, namely for each of the photo diodes 128a in the photoreceptor array 128.

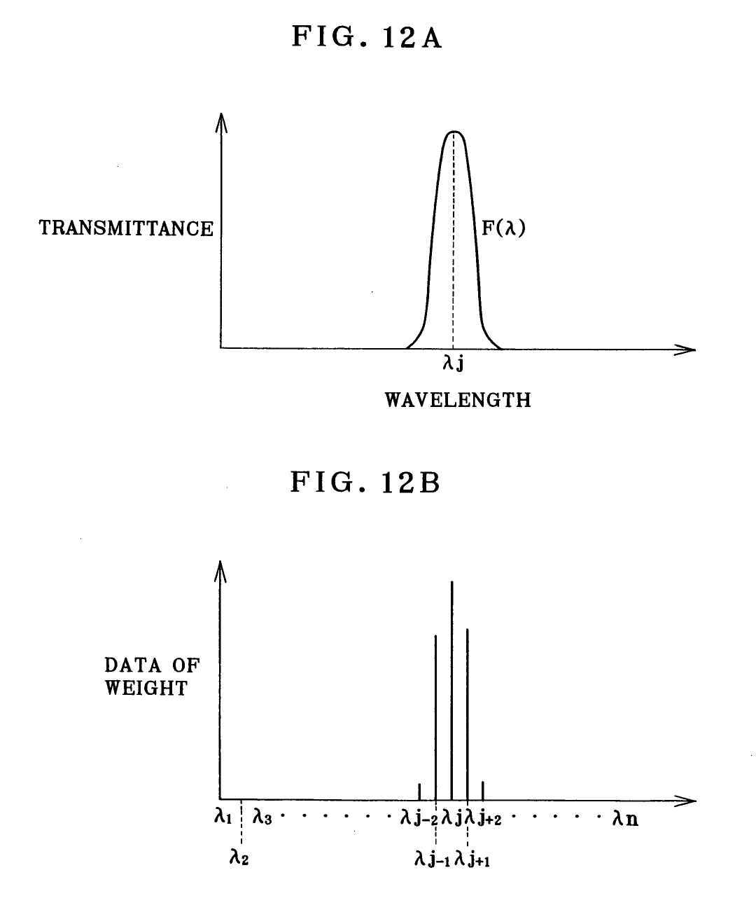

In FIG. 12A, one example of the band-pass filter measurement is depicted. A band-pass filter being used has a transmittance F(λ) as a function of a wavelength λ. The band-pass filter with the transmittance of FIG. 12A is used in measurement with the central wavelength λⱼ as a specific wavelength. The band-pass filter also has somewhat high transmittance in wavelength regions before and after the central wavelength λⱼ. A distribution of the transmittance is in a shape of a curve with a peak at the wavelength λⱼ.

Data of weight is determined to sample the transmittance F(λ) at an interval of sampling period (wavelength) of the illuminating light for a wavelength band of sampling the illuminating light. So the data of weight is regarded as equivalent to transmittance for a wavelength λᵢ of the band-pass filter. For example, the data of weight of FIG. 12B is determined in correspondence with the band-pass filter with a characteristic of FIG. 12A. In FIG. 12B, the data of weight corresponding to the wavelength from λⱼ₋₂ to λⱼ₊₂ is greater than zero (0). The data of weight for the wavelength λⱼ is the greatest. For other wavelengths, transmittance of the band-pass filter is 0%, so that the data of the weight is zero (0). It is noted that a wavelength associated with the data of the weight is regarded as coincident with a wavelength where the transmittance of the band-pass filter is maximized. However, this coincidence may not be necessary for the reason that a wavelength associated with the data of the weight is constituted by a wavelength band with a bandwidth.

Let Di be photoelectric data associated with the wavelength λᵢ where i is 1, 2, . . . , n. Let Wi be data of weight associated with the wavelength λᵢ. The spectrally weighted data processor 114 calculates the measured data I according to Equation 1 below. When the light is measured according to the band-pass filter measurement of the known technique, a measured value I0 of a specific wavelength is expressed by Equation 2, where S(λ) is the reflectance, and F(λ) is the band-pass filter transmittance. Note that the measured value I0 obtained from Equation 2 is equal to a value of when n is infinity according to Equation 1. In other words, the measured data I obtained from Equation 1 is equivalent to measured value I0 according to band-pass filter measurement.

$$\begin{matrix}I = [ {\sum }_{i = 1}^{n} ( Wi \cdot Di ) ] / [ {\sum }_{i = 1}^{n} Wi ] & Equation 1 \\ I0 = [ \int F ( λ ) \cdot S ( λ ) ⅆ λ ] / [ \int F ( λ ) ⅆ λ ] & Equation 2\end{matrix}$$

The spectrally weighted data processor 114 transmits the measured data to the microcomputer 110 of the terminal device 105. In FIG. 10, a data storage 110a is connected with the microcomputer 110, and stores the programs or applications mentioned above. The microcomputer 110 executes the density converting program, and convert the measured data to content of the target biomaterial. Steps of the conversion includes a step of minus-logarithm processing for converting the reflectance of the measured data to the reflection density according to the following equation, and a step of calibrating processing for converting the reflection density being obtained to content of the target biomaterial by referring to a calibration curve.
Reflection density=−log₁₀ (Reflectance)

Note that the calibration curve processing is based on the reflection density from the minus logarithm processing in combination with a density converting equation as a relationship between the content of the target biomaterial and the reflection density. A plurality of density converting equations are predetermined for each of possible target biomaterials, and are stored in the data storage 110a. Those density converting equations are determined according to calibration curves of the band-pass filter measurement which has been widely used in the field of biochemical analysis. It is also to be noted that although the minus logarithm processing and calibration curve processing are made in the terminal device 105 in the embodiment, those can be made in the spectrophotometer 109 or an analyzer main unit in the analyzer body 104.

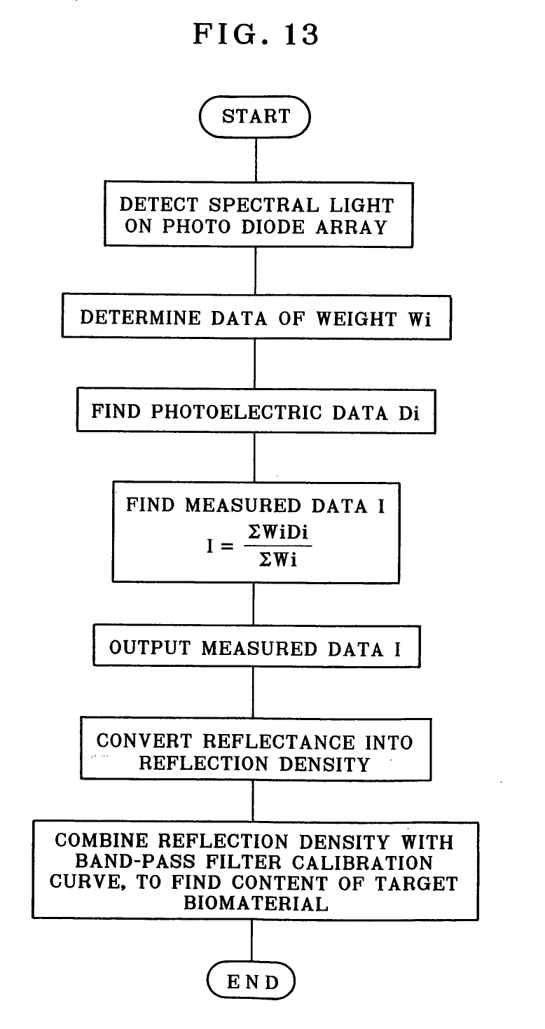

The operation of the embodiment is described now by referring to FIG. 13. After a fluid sample is dropped on the multi-layer film 103a of the analysis slide 103, the analysis slide 103 is incubated by the incubator 108. The analyzer is ready with the analysis slide 103 in this state. For an assay, the keypad 112 is operated to determine a target biomaterial, before an instruction signal for start is input. Then n data of weights are read from the ROM 113a according to the specific wavelength associated with the designated target biomaterial, and transmitted to and set in the spectrally weighted data processor 114.

After setting the data of the weights, the light source 117 is turned on by the control of the controller 113, and applies illuminating light to a surface of the analysis slide 103 through the condenser lens 118. The illuminated light is scattered by the surface of the reaction layer of the multi-layer film 103a, and reaches the concave diffraction gratings 127 after passage of the slits 125a and 126a. Owing to varying states in the color of the multi-layer film 103a, intensity of scattered light varies per each of the wavelengths of the light. The illuminating light is separated and reflected by the concave diffraction gratings 127 to travel to the photoreceptor array 128. The photoreceptors or photo diodes 128a in the photoreceptor array 128 output detection signals according to levels of light intensity of the illuminating light.

A detection signal output by each of the photo diodes 128a is converted into photoelectric data by the A/D converter 129, and sent to the spectrally weighted data processor 114. So the n photoelectric data are input. The spectrally weighted data processor 114 calculates measured data by processing according to Equation 1 above by use of the n data of weight preset by the controller 113 and the n photoelectric data. The measured data are sent to the terminal device 105.

Upon inputting the measured data, the microcomputer 110 operates for the minus logarithm processing to convert the reflectance included in the input measured data into reflection density. Then the density converting equation for the calibration curve processing associated with the target biomaterial designated at the keypad 112 is read from the data storage 110a. The content of the target biomaterial is obtained by substitution of the reflection density in the density converting equation. Information of the obtained content of the target biomaterial is displayed on the LCD display panel 111.

As described heretofore, the measured data is calculated according to the data of weight in addition to the photoelectric data. The reflectance expressed by the measured data is equivalent to measured values or reflectance obtained when a band-pass filter is used to receiving light selectively for a specific wavelength. Thus, the content of the specific biomaterial in the sample for a specific wavelength can be found because the reflection density according to the measured data can be combined with the measurement of the prior art by use of a calibration curve adapted to band-pass filters. Also, different specific wavelengths of reflected light can be handled to obtain measured data of reflectance only by changing the data of weight in the calculation. Consequently, measured data can be obtained rapidly even for various specific wavelengths in comparison with the conventional technique in which band-pass filters mechanically are changed over from one another.

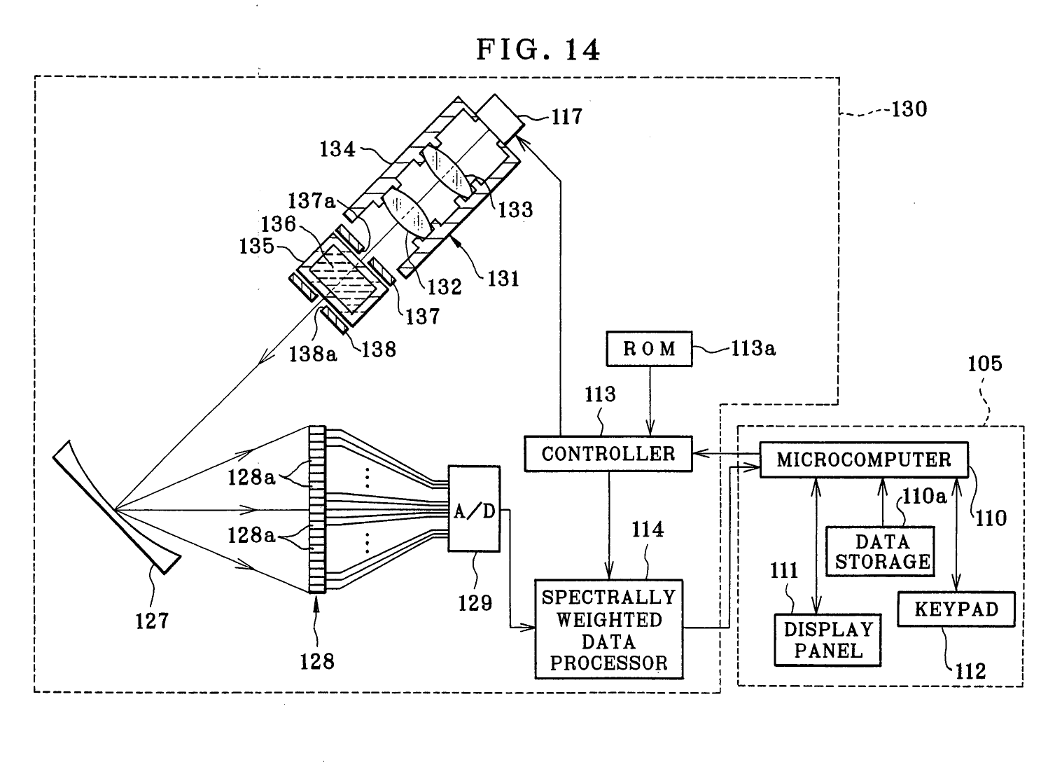

One preferred embodiment is described with reference to FIG. 14. A spectrophotometer 130 measures transmittance at a specific wavelength. Elements similar to those of the above embodiment are designated with identical reference numerals.

An illuminator 131 includes a lens barrel 134, two lens elements 132 and 133 and the light source 117. The lens barrel 134 supports the lens elements 132 and 133 and the light source 117 inside. The light source 131 emits illuminating light generated by the light source 117 in a controlled manner for a suitably adjusted diameter of flux in a parallel form. A transparent sample vessel 135 is disposed in front of the light source 131. A fluid sample 136 is filled in or contained in the transparent sample vessel 135. A slit-formed panel 137 is disposed beside the fluid sample 136. A slit 137a is formed in the slit-formed panel 137 and disposed in a path of light from the light source. Also, a slit-formed panel 138 is disposed beside the fluid sample 136 and on an opposite side from the slit-formed panel 137. A slit 138a is formed in the slit-formed panel 138 and disposed in the path of light.

Illuminating light emitted by the light source 131 is passed through the slit 137a and into the fluid sample 136 filled in the transparent sample vessel 135, and comes through the slit 138a to become incident upon the concave diffraction gratings 127. The concave diffraction gratings 127 optically separate and reflect the illuminating light, and causes light to travel to the photoreceptor array 128. In the processing similar to that of the above embodiment, measured data representing reflectance of the fluid sample 136 for the specific wavelength is obtained. The reflectance of the measured data is converted into the reflection density according to the equation of
Reflection density=−log₁₀ (Reflectance)

The reflection density being obtained is converted to content of the target biomaterial by referring to a calibration curve of a relationship between the reflection density and the content of the target biomaterial.

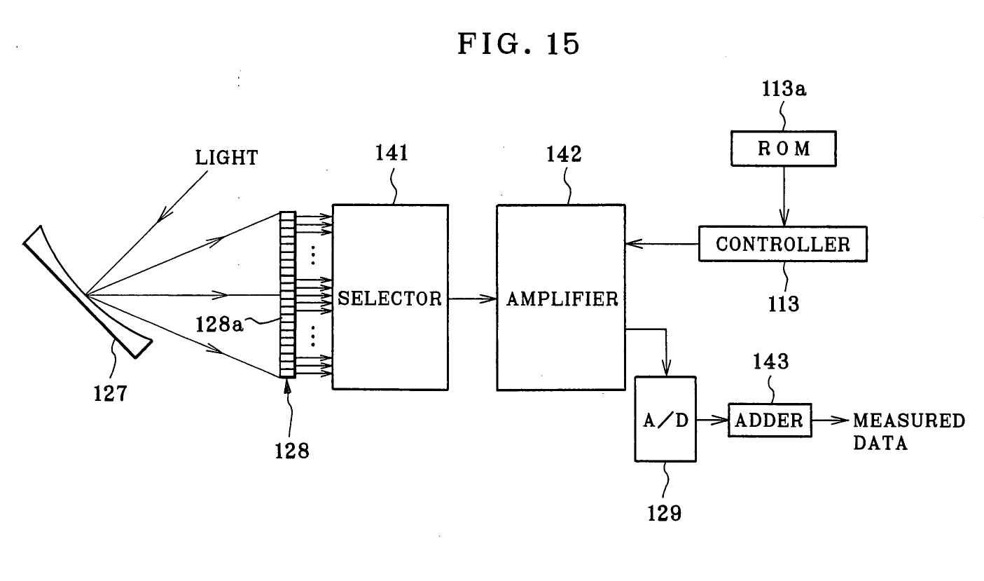

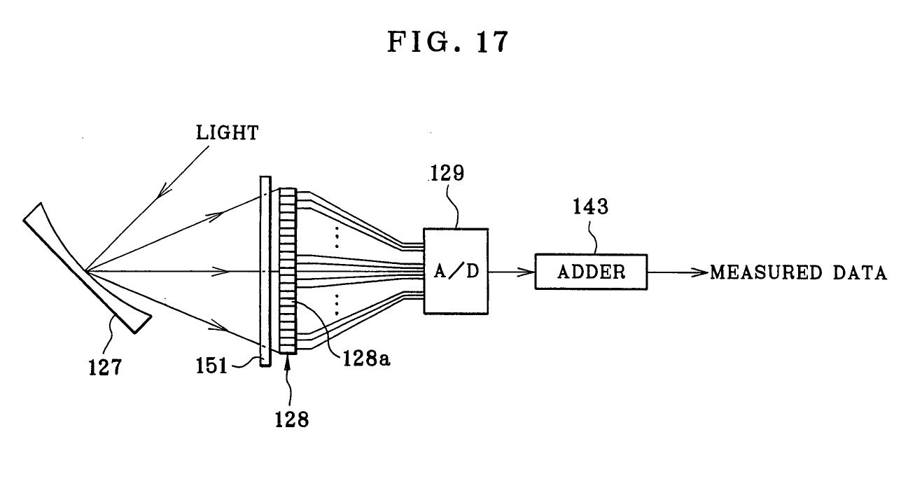

Another preferred embodiment is described now. Elements in the embodiment and still another embodiment to be described later similar to those in the preferred embodiments of FIGS. 8A-14 are designated with identical reference numerals. Note that in FIGS. 15 and 17, the light source, the terminal device and the like are not depicted for simplification.

In FIG. 15, an amplifier 142 is connected with the photoreceptor array 128 via a selector 141. The selector 141 is controlled by the controller 113, and changes over detection signals of the photoreceptors or photo diodes 128a from a short wavelength to a long wavelength in transmission of those to the amplifier 142. The amplifier 142 operates for imparting weights to the detection signals, and amplifies the detection signals input at an amplification factor determined by the controller 113.

The ROM 113a stores amplification factors preset for respectively specific wavelengths, namely for respectively the photo diodes 128a in the photoreceptor array 128. The controller 113 reads the amplification factors from the ROM 113a according to specific wavelengths to be assayed, and sequentially sets the amplification factors in the amplifier 142 one after another in synchronism with the changeover of the selector 141. Thus, the detection signals output by the photo diodes 128a for the respective wavelengths are amplified at amplification factors associated with the wavelengths. There is an adder 143 which adds up the digital data obtained from the A/D converter 129 by conversion of the amplified detection signal. The adder 143 outputs measured data by the addition.

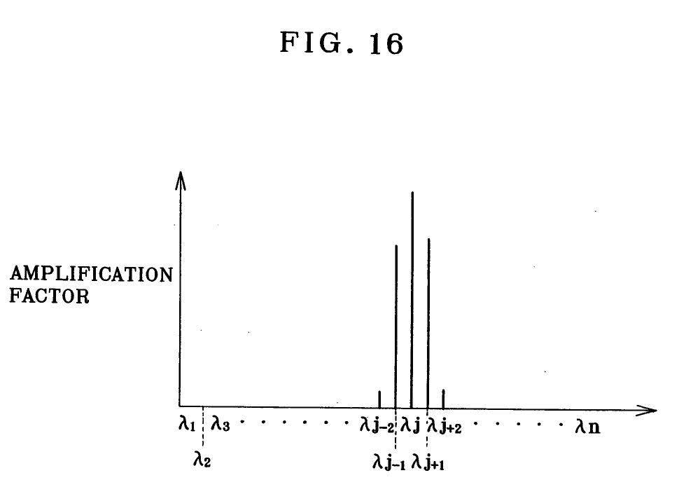

The amplification factors for the specific wavelengths are prepared according to the characteristic of the transmittance of the band-pass filter. In FIG. 16, an example of a relationship between the wavelengths and the amplification factors is depicted. An amplification factor for a wavelength with high transmittance of the band-pass filter is determined high. An amplification factor for a wavelength with low transmittance of the band-pass filter is determined low. The measured data being obtained can be determined equivalent to measured data obtained by reception of light in a wavelength band selective by use of the band-pass filter.

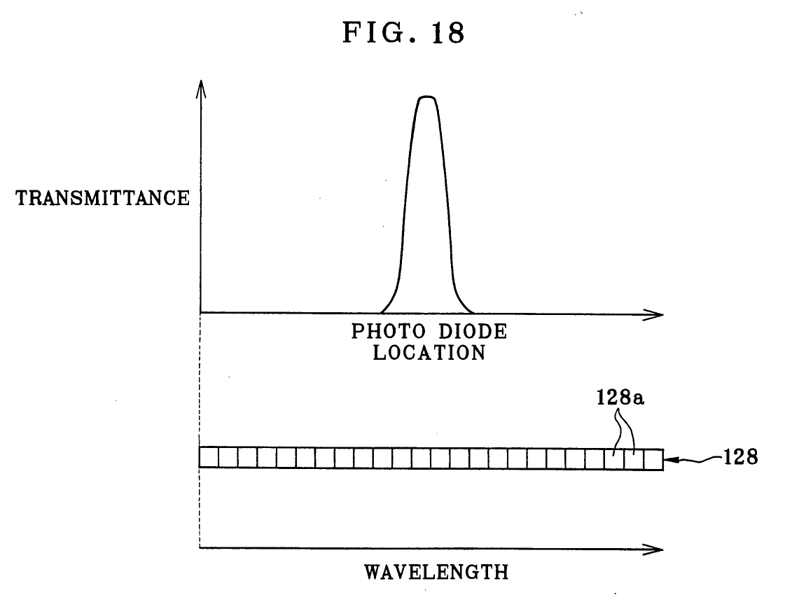

In FIG. 17, another preferred embodiment is illustrated. A transmittance distribution filter 151 is disposed in front of the photoreceptor array 128 for weighting detection signals. In FIG. 18, transmittance of the transmittance distribution filter 151 is illustrated. The transmittance varies in the direction of arrangement of the photoreceptors or photo diodes 128a, namely the direction of dispersion of the reflected light. The transmittance is changeable according to a change in a wavelength of the detected light. A relationship between the transmittance and the wavelength is predetermined equal to that of band-pass filters. Detection signals from the photo diodes 128a are converted into a digital form by the A/D converter 129, and added up by the adder to output measured data. It is possible to obtain measured data equivalent to data according to receiving light selectively of a specific wavelength by use of band-pass filter.

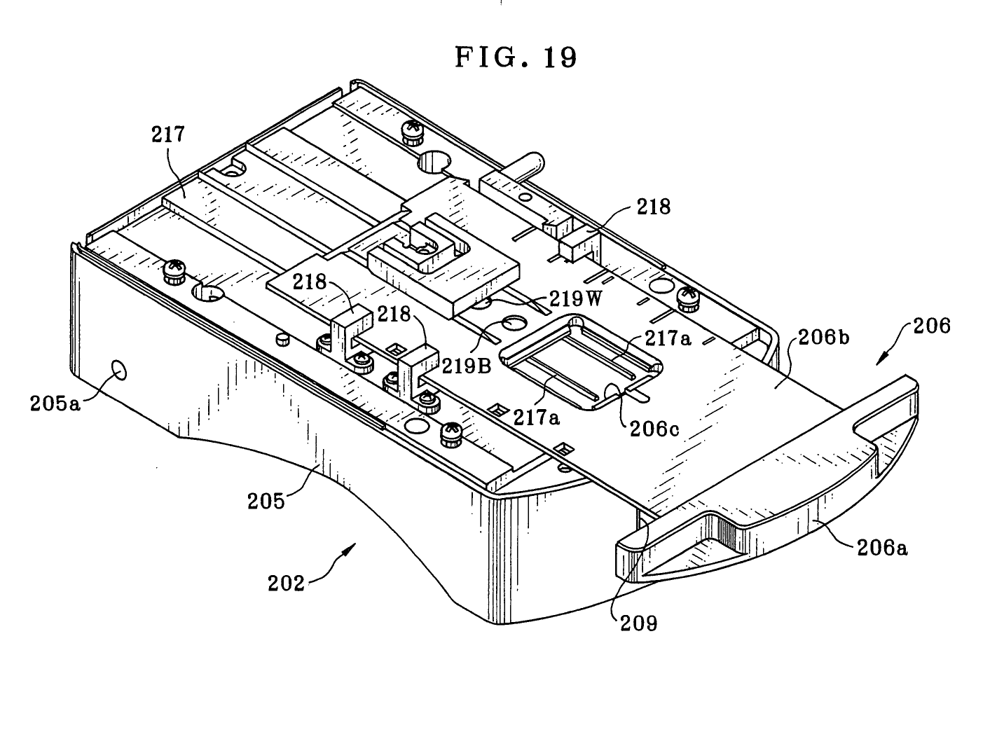

Still another preferred embodiment is described now with reference to FIGS. 19-28. in the prior art, plural suggestions have been made for the use of a light-emitting diode (LED) as light source. U.S. Pub. No. 2004/090,615 (corresponding to JP-A 2004-151099) discloses a reflectance reader of the diffuse reflection, and suggests a use of an LED light source. However, a filter and a monochromatic light source are combined. Multi-wavelength measurement is extremely difficult, for examples at wavelengths of 400, 505, 540, 570, 600, 625 and 650 nm. JP-A 8-250767 discloses an LED light source of nitride semiconductor, with which purity of the color can be set high together with shifting of a peak of light emission. However, there is a certain wavelength of which a high intensity of light cannot be obtained according to this disclosure. Assay of biomaterials in an accurate manner is impossible even in using the suggested nitride semiconductor in biochemical analysis.

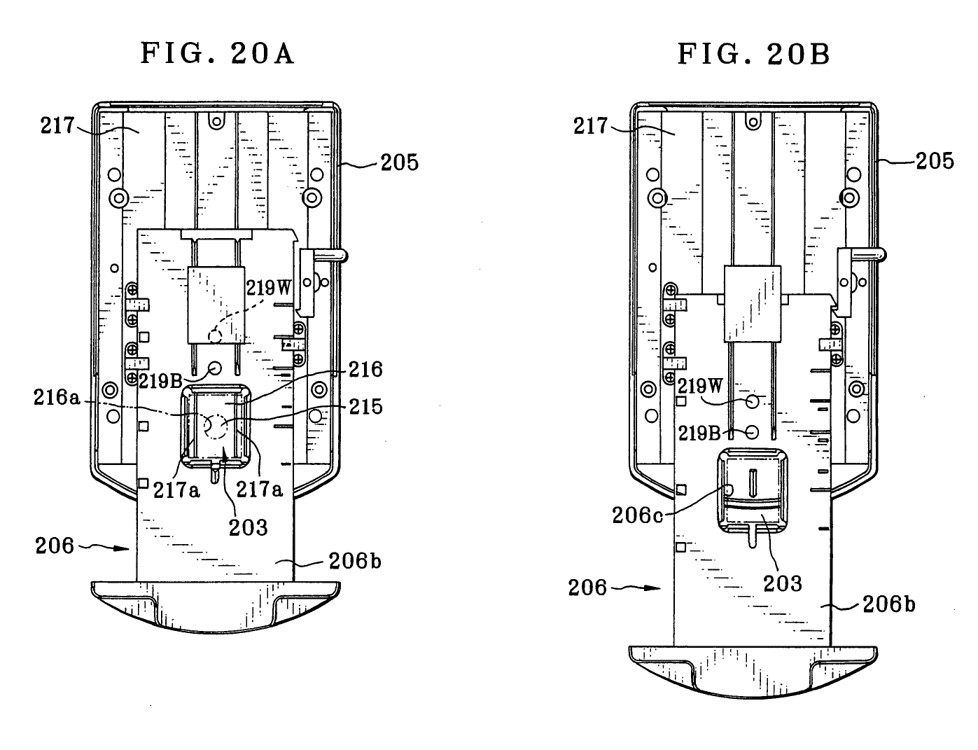

According to the invention, one biochemical analyzer 202 in FIG. 19 is structurally the same as that depicted in FIGS. 1A and 1B. The biochemical analyzer 202 is a quantitative analysis unit for use with a sample slide or analysis slide 203 having an assay surface, and assays the sample in the optical assay unit 203 by the quantitative analysis in a form of data of the content of a biomaterial contained in the sample. The biochemical analyzer 202 includes an upper cover (not shown), a lower cover 205 and a transfer tray or sample holder 206. The transfer tray 206 transfers the analysis slide 203 supported thereon. Also, the transfer tray 206 is movable in forward and backward directions. FIG. 1A illustrates a state of the transfer tray 206 set in the measuring position for assaying the analysis slide 203. FIG. 1B illustrates a state of the transfer tray 206 in the initial set position for setting the analysis slide 203. The transfer tray 206 is movable between the measuring position of FIG. 1A and the exit position of FIG. 20B. An exit channel 209 is formed in the biochemical analyzer 202. The transfer tray 206, when in the exit position, is in front of the initial set position, and causes the analysis slide 203 to exit through the exit channel 209. Note that a term of a forward direction is hereinafter used to stand for a direction toward the front. A term of a backward direction is used to stand for a direction toward the inside.

An incubator 208 is contained under the upper cover. A heater is included in the incubator 208, and maintains the analysis slide 203 at a constant temperature for a prescribed time. The exit channel 209 is formed in the front panel of the lower cover 205 for exiting the analysis slide 203 after the analysis. A connection interface 205a is positioned on a left lateral panel of the lower cover 205. A terminal device 210 as user interface in a quantitative analysis unit is electrically connected by the connection interface 205a with the biochemical analyzer 202. An example of the terminal device 210 is a PDA (Personal Digital Assistant) of a general-purpose type. Programs for analysis are installed by means of a memory card or the like. When each of the programs is started up, the terminal device 210 can operate for the analysis according to relevant items of processing. The terminal device 210 includes an LCD display panel 211 and a keypad 212. A plug (not shown) of a connection line (not shown) is inserted in the connection interface 205a for connecting the terminal device 210 with the biochemical analyzer 202. The LCD display panel 211 displays a message for encouraging a user to operate, information of results of analyzing the sample in the analysis slide 203, and the like. A user operates the keypad 212 by viewing the LCD display panel 211. An inner power source is contained in a space of the lower cover 205. An example of the inner power source is four batteries of the type AA. Various elements are supplied with power by the inner power source, including the incubator 208, a position detector 218, an LED light source or illuminator 221, a motor 225, photoreceptors or photo diodes 229, a control circuit board 250 and the like.

In FIG. 20A in combination with FIG. 9, the analysis slide 203 includes a multi-layer film 215 and a slide frame 216 for supporting the multi-layer film 215. A circular hole 216a is formed in an upper panel of the slide frame 216 for spotting a fluid sample on a developing layer. An optical assay hole is formed in a lower panel of the slide frame 216 on the transparent support. The multi-layer film 215 is a laminate of a transparent support, a reagent layer of reaction, a reflection layer, and a developing layer. The reagent layer of reaction contains dry reagent. The sample is dropped on the developing layer. For the assay, the reagent layer of reaction is viewed through the support. The sample is spread uniformly on the developing layer, penetrates through the reflection layer, and reaches the reagent layer of reaction. The reagent layer of reaction reacts on the sample to develop visible color. Density of developed color is proportional to a content of the biomaterial in the sample. Examples of fluid samples are whole blood, serum, blood plasma, urine and the like.

In FIGS. 19, 20A and 20B, a transfer rail 217 is incorporated in a space in the lower cover 205 for keeping the transfer tray 206 movable. Two supports 217a or rail ridges are formed at the center of the transfer rail 217, for supporting the analysis slide 203. The transfer tray 206 includes a grip 206a and retention panels 206b. The grip 206a is held manually by a user, has a shape readily to be grasped, for moving the transfer tray 206.

A slide holder opening 206c is formed in the retention panels 206b for receiving the analysis slide 203. A size of the slide holder opening 206c is equal to or larger than a size of the analysis slide 203. The transfer tray 206 is set on the transfer rail 217 and then shifted to the initial set position of FIG. 20A for setting of the analysis slide 203. At this time, the supports 217a appear through the slide holder opening 206c. When the analysis slide 203 is fitted in the slide holder opening 206c, sides of the analysis slide 203 is retained on the retention panels 206b. A lower panel of the analysis slide 203 is supported on an upper end of the supports 217a. An air layer is formed between the analysis slide 203 and the transfer rail 217. Also, an area of contact between the analysis slide 203 and the supports 217a is considerably small, because a width of an upper edge of the supports 217a is small. In FIG. 20B, the supports 217a have such a length as not to appear in the slide holder opening 206c when the transfer tray 206 is set in the exit position. The analysis slide 203 is allowed to exit through the exit channel 209 upon shifting the transfer tray 206 to the exit position, because set free from the supports 217a.

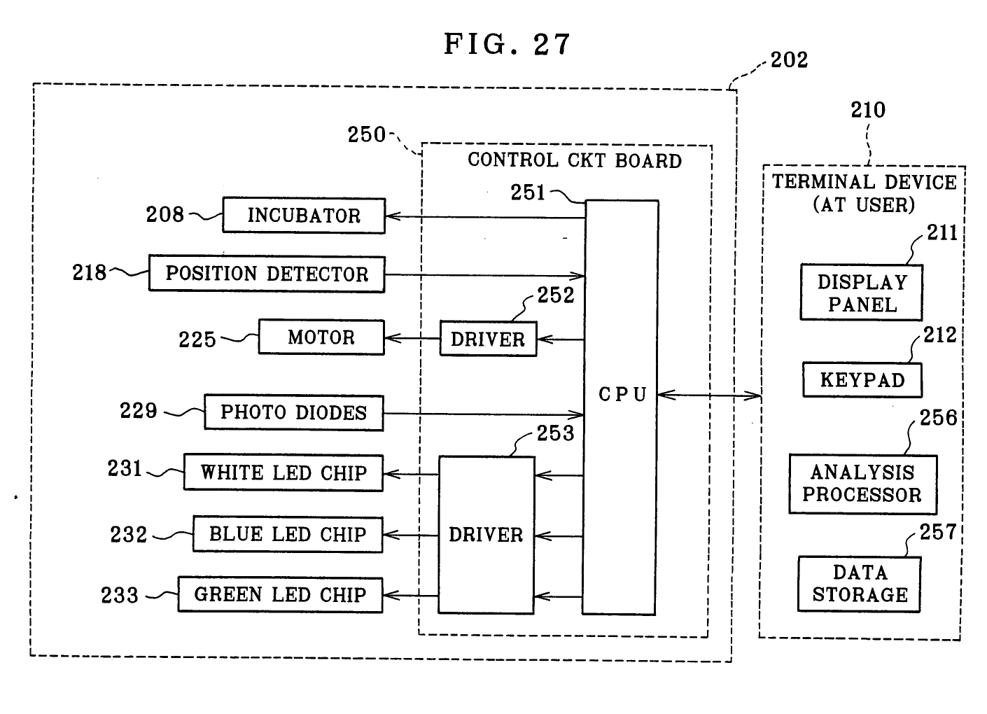

The position detector 218 is disposed at each of two sides along the transfer rail 217 for detecting a position of the transfer tray 206. A CPU 251 of the control circuit board 250 is connected with the position detector 218, which generates a position signal of a detected position of the transfer tray 206. See FIG. 27.

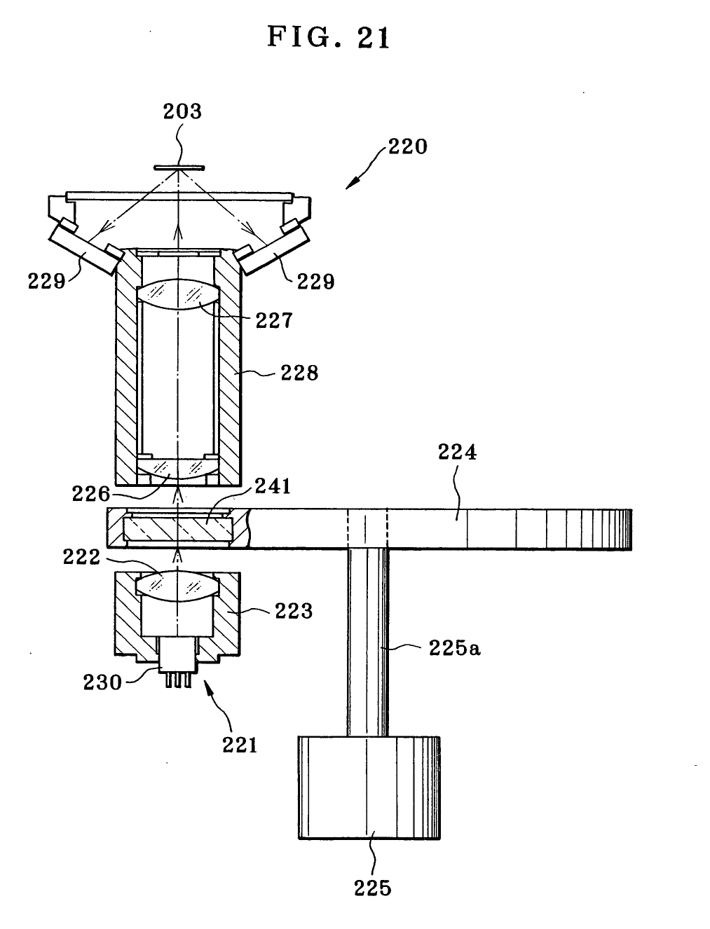

A reference white region 219W and a reference black region 219B or white and black plates are disposed on the retention panels 206b and positioned backward from the slide holder opening 206c. The reference regions 219W and 219B are circular. The reference regions 219W and 219B are previously inserted in the retention panels 206b through a lower surface of the retention panels 206b for firm attachment. A photometric unit or optical assay unit 220 of FIG. 21 measures light when the reference regions 219W and 219B is positioned directly over the optical assay unit 220 at the center of the lower cover 205 in movement of the transfer tray 206. The transfer tray 206 is settable in a first position of locating the reference black region 219B at the optical assay unit 220, and a second position of locating the reference white region 219W at the optical assay unit 220. For each of the first and second positions, the transfer tray 206 can be retained with a small firmness by a mechanism for clicking. This makes it easy to measure reflected light from the reference regions 219W and 219B.

The optical assay unit 220 at the center of the lower cover 205 in FIG. 21 is not illustrated in FIGS. 1 and 19. The optical assay unit 220 applies illuminating light to the analysis slide 203, and measured intensity of the reflected illuminating light from the analysis slide 203. Elements in the optical assay unit 220 include the LED light source 221, a first condenser lens 222, a first lens barrel 223, a filter turret or wheel 224, the motor 225, a second condenser lens 226, a third condenser lens 227, a second lens barrel 228 and the photo diodes 229. The number of the photo diodes 229 may be three or more instead of the two. Also, any photoreceptor, photo sensor or other detecting device may be used in place of the photo diodes 229 for the purpose of measuring intensity of the reflected illuminating light from the analysis slide 203.

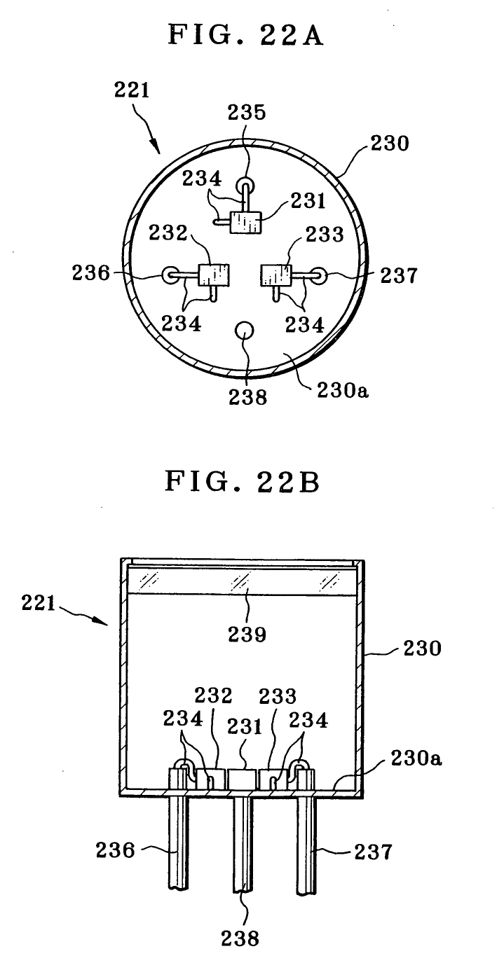

In FIGS. 21, 22A and 22B, the LED light source 221 includes a can or metal case 230, a white LED chip 231, a blue LED chip 232 and a green LED chip 233. A base panel 230a of the metal case 230 supports the LED chips 231, 232 and 233 mounted thereon. The LED chips 231, 232 and 233 are arranged on a circle in a concentric manner and on end points of a regular triangle. A central angle of the rotational interval between those is 120 degrees. Two lines 234 are connected with each of the LED chips 231-233. A first one of the lines 234 is connected with the base panel 230a for a grounded connection. A second one of the lines 234 is connected with leads 235, 236 and 237. Each of a grounded line 238 and the leads 235-237 has a first end connected with the base panel 230a, and a second end connected with the control circuit board 250. A glass protector 239 is attached to the inside of the metal case 230 and located on a light path of light from the LED chips 231-233. In FIG. 22A, a top of the metal case 230 is viewed. In FIG. 22B, the metal case 230 is viewed in section.

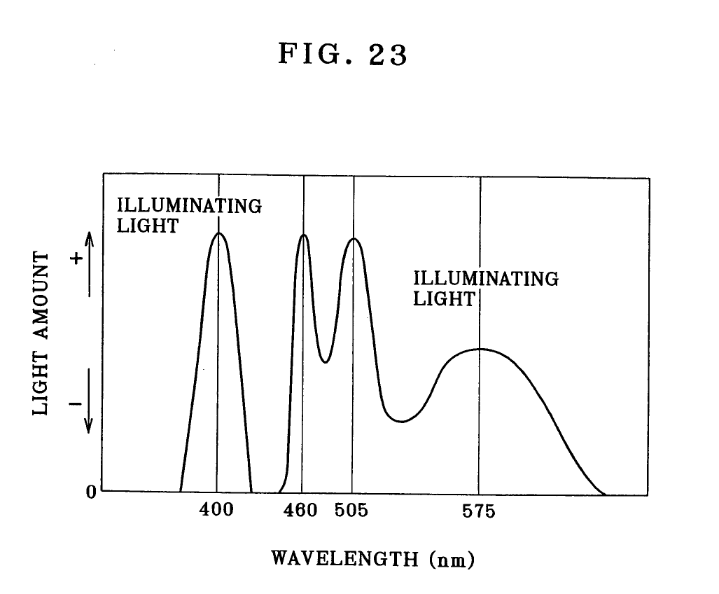

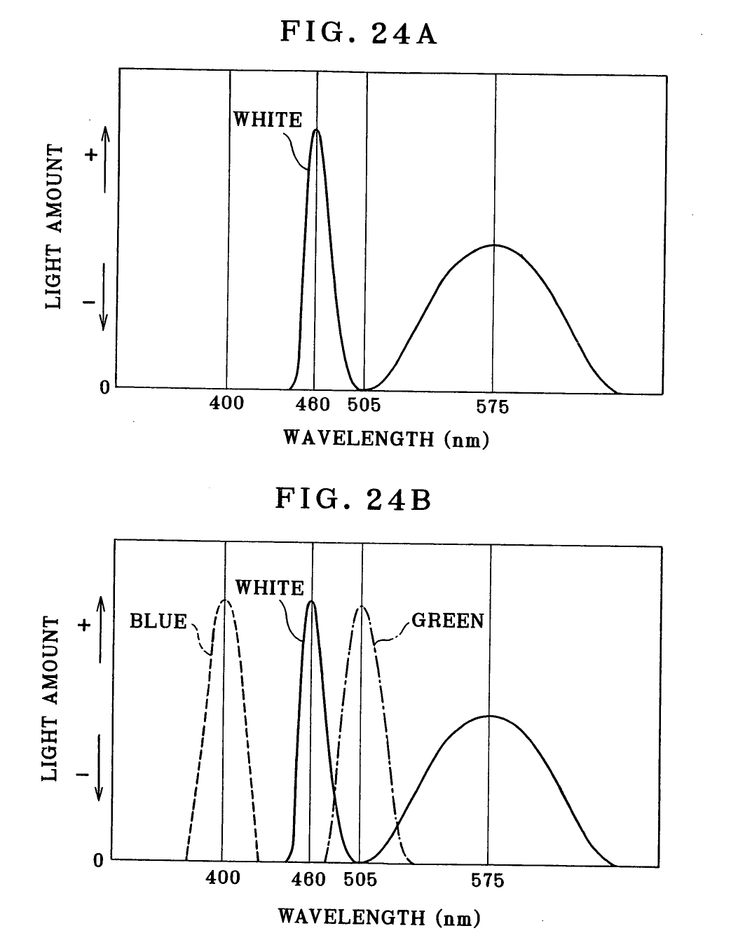

The LED light source 221 emits light in the distribution illustrated in FIG. 23. The white LED chip 231 emits white light in the distribution illustrated in FIG. 24A. Two peaks are included in the white light, namely at approximately 460 nm for excitation of light, and at approximately 575 nm for fluorescence. If only the white LED chip 231 is used in the biochemical analyzer 202 for 27 items of biochemistry and immunology, there is a shortage of light at wavelengths of particularly 400-460 nm and approximately 505 nm. No quantitative analysis is possible accurately for the sample on the analysis slide 203 if only white light is used. Therefore, the blue LED chip 232 is used for addition or reinforcement to apply blue light of which a wavelength peaks at approximately 400 nm as indicated by the broken line in FIG. 24B. Also, the green LED chip 233 is used for addition or reinforcement to apply green light of which a wavelength peaks at approximately 505 nm as indicated by the phantom line in FIG. 24B. Thus, the LED light source 221 can emit illuminating light of plural components as illustrated in the graph of FIG. 23.

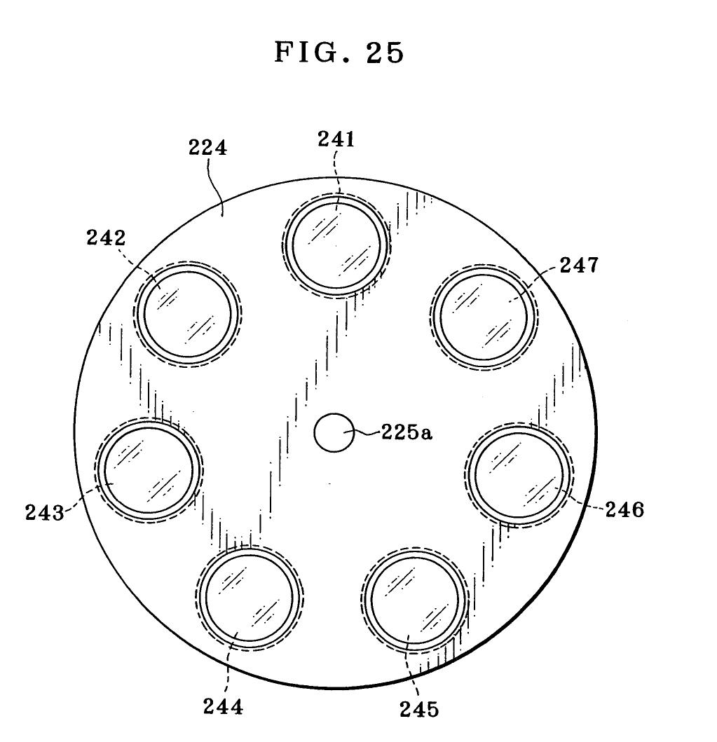

In FIGS. 21 and 25, the filter turret 224 has a disk shape. Seven band-pass filters 241-247 are assembled on the filter turret 224, arranged on a concentric circle and at a regular angular pitch. The band-pass filters 241-247 are associated with specific wavelength bands to allow light of their wavelength bands to pass. The first band-pass filter 241 transmits light of a specific wavelength of 400 nm. The second and third band-pass filters 242 and 243 transmit light of specific wavelengths of 505 and 540 nm. The fourth, fifth, sixth and seventh band-pass filters 244, 245, 246 and 247 transmit light of specific wavelengths of 570, 600, 625 and 650 nm. Note that the specific wavelength bands of transmission of the band-pass filters can be modified for the purpose of items of the analysis.

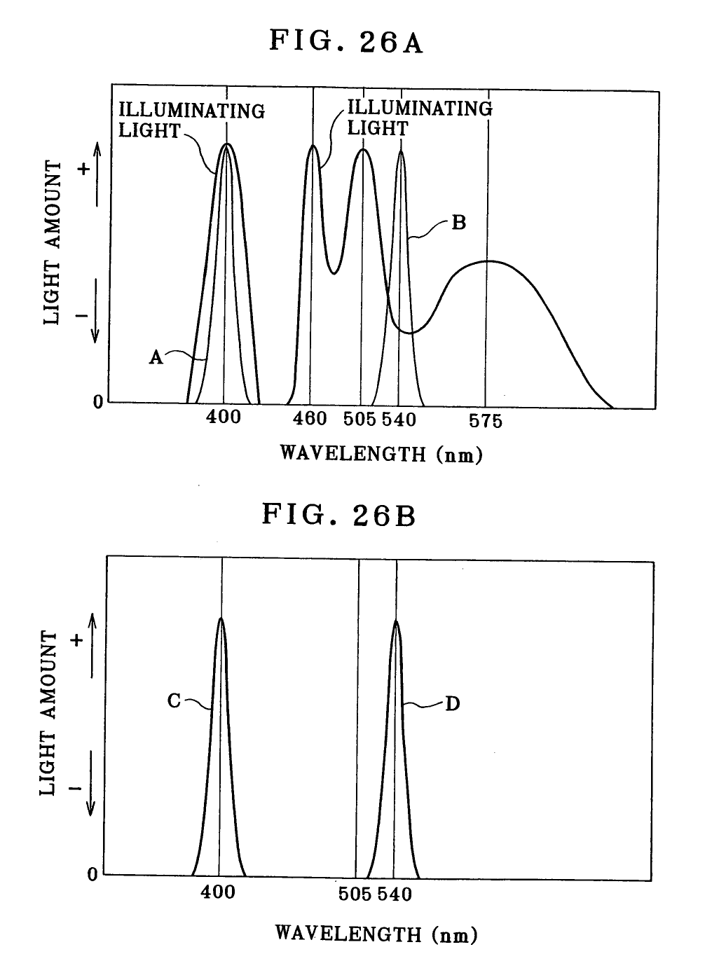

In FIG. 26A, a curve A indicates a wavelength band of light transmissible by the first band-pass filter 241. A curve B indicates a wavelength band of light transmissible by the third band-pass filter 243. In FIG. 26B, a curve C indicates a wavelength band of light transmitted by the first band-pass filter 241. A curve D indicates a wavelength band of light transmitted by the third band-pass filter 243.

In FIG. 21, an output shaft 225a of the motor 225 is secured to the center of the filter turret 224. The motor 225 causes the filter turret 224 to rotate. The filter turret 224 being stopped, a selected one of the band-pass filters 241-247 is rotationally positioned at the LED light source 221 with reference to its light path by control of the motor 225. In FIG. 27, the motor 225 is connected with and controlled by the CPU 251 of the control circuit board 250. Note that a filter selector of the embodiment is constituted by the filter turret 224 and the motor 225.

The condenser lenses 226 and 227 are mounted in the second lens barrel 228. Illuminating light emitted by the LED light source 221 is condensed by the first condenser lens 222, is passed through a selected one of the band-pass filters 241-247 positioned in front of the LED light source 221, and becomes incident upon the analysis slide 203 after passing the condenser lenses 226 and 227.

Illuminating light for assay comes incident upon the analysis slide 203, and reflected thereon, and then becomes incident upon the photoreceptors or photo diodes 229. The photo diodes 229 convert the scattered light of the diffuse reflection from the analysis slide 203, to output a detection signal by photoelectric conversion. The detection signal from the photo diodes 229 is sent to the control circuit board 250 contained in the lower cover 205. In FIG. 27, an analysis processor 256 of the terminal device 210 is provided with the detection signal by the CPU 251 on the control circuit board 250. When the reference regions 219W and 219B are set in the incident positions described above, scattered light of the diffuse reflection from the reference regions 219W and 219B illuminated by the LED light source 221 is measured by the photo diodes 229. The detection signals of the reference regions 219W and 219B are transmitted to the analysis processor 256 in the terminal device 210 by the CPU 251 on the control circuit board 250, and converted logarithmically into data of reference optical density. A data storage 257 is caused by writing of the analysis processor 256 to store the data of the reference optical density.

In FIG. 27, drivers 252 and 253 and the CPU 251 are mounted on the control circuit board 250. The CPU 251 controls the drivers 252 and 253 according to instruction signals from the terminal device 210 and position signals from the position detector 218, to drive the motor 225, the photoreceptors or photo diodes 229, the LED chips 231-233 and the heater in the incubator 208. A selected one of the band-pass filters 241-247 according to an item for analysis is set on the light path of the LED light source 221, photometrically measures the reference regions 219W and 219B and the analysis slide 203 according to moving of the transfer tray 206. A result of the measurement is sent by the CPU 251 to the analysis processor 256 of the terminal device 210. Note that the incubator 208 is driven before assaying the analysis slide 203, and maintains the analysis slide 203 at a given temperature for a prescribed time.

The data storage 257 is incorporated with the analysis processor 256 in the terminal device 210. The analysis processor 256 calibrates the optical density of the analysis slide 203 according to the reference densities of the reference regions 219W and 219B, and obtains data of biomaterial content according to the calibration curve previously stored according to the calibrated density of the analysis slide 203. The data of the content is written together with the assay identification data. Also, the LCD display panel 211 is driven to display results of the analysis. The data of the content in the data storage 257 can be read and output to an external device such as a computer together with the assay identification data. Results in a series obtained from the same one of the patients can be sorted and displayed on a time axis, and can be expressed in a graph. Note that relevant software or applications for processing can be added to the terminal device 210 if required, so as to manage various data within the terminal device 210 itself. A calibration curve is a form of a function to express a relationship between optical density of the analysis slide 203 and data of the content by analyzing the biomaterial. It is possible with the calibration curve to find data of the contents by viewing the density. If desired, applications and calibration curves can be rewritten for the purpose of performing other analyses and assays.

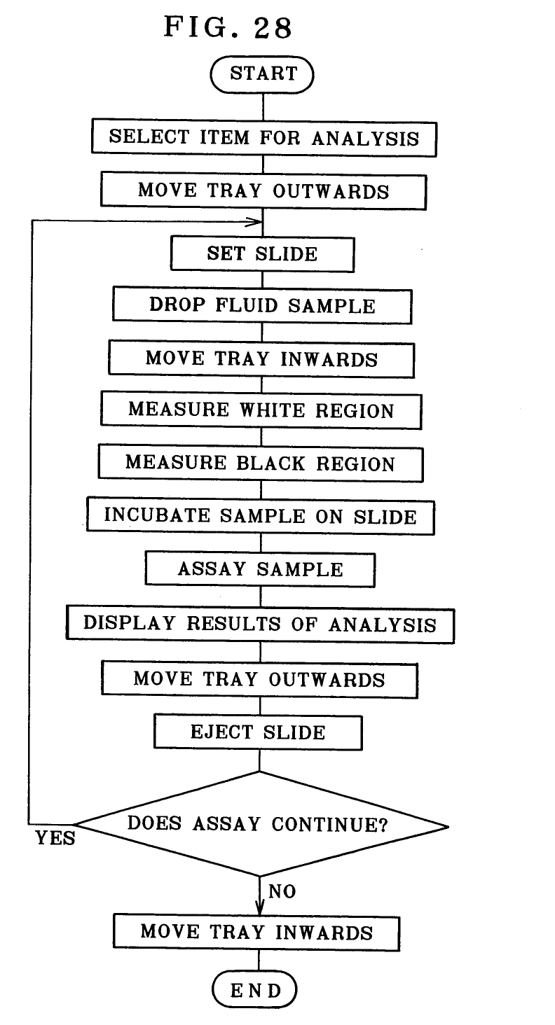

The operation of the above construction is described now with FIG. 28 for a flow. The biochemical analyzer 202 is driven only by supply of power of the inner power source, and also is portable and suitable for easy handling. A user can use the biochemical analyzer 202 freely in an easy manner.

The power switch for the biochemical analyzer 202 is turned on. The terminal device 210 is connected with the biochemical analyzer 202. Then the LCD display panel 211 in the terminal device 210 is caused to display a selection menu for items of analysis. A selected one of the items is designated, to start a flow of processing. At first, one of the band-pass filters 241-247 is selected for the designated item, and mechanically set on the light path of the LED light source 221. Then a message for encouraging the pull of the transfer tray 206 is indicated. When the transfer tray 206 is pulled out to the initial set position, the LCD display panel 211 of the terminal device 210 displays a message for encouraging setting the analysis slide 203 and dropping fluid sample. Also, the heater in the incubator 208 is started for preheating.

The user, after dropping the fluid sample on the analysis slide 203 set in the transfer tray 206, presses the transfer tray 206 to thrust in. In the movement, the reference regions 219W and 219B are successively measured by the optical assay unit 220 by light measurement. To the reference regions 219W and 219B, illuminating light emitted by the LED light source 221 and passed through any of the band-pass filters 241-247 is applied. The illuminating light emitted by the LED light source 221 has a white light component emitted by the white LED chip 231 and also blue and green light components emitted by the blue and green LED chips 232 and 233. Light of a sufficient intensity can be obtained by use of any one of the band-pass filters 241-247. The detection signals of the reference regions 219W and 219B are sent to the analysis processor 256 by the CPU 251, and converted to data of reference optical density in a logarithmic form.

When the transfer tray 206 is set in the measuring position by pressure in an inward direction, the analysis slide 203 is positioned directly higher than the optical assay unit 220. The incubator 208 maintains the analysis slide 203 at a regular temperature for a prescribed time, so that a reaction layer in the analysis slide 203 can develop color at density corresponding to the content of a target biomaterial.

Then the analysis slide 203 is photometrically assayed by the optical assay unit 220 after the incubation. A detection signal is generated, and sent via the CPU 251 to the analysis processor 256, which obtains optical density data. The analysis processor 256 calibrates the optical density data according to reference data represented by the reference regions 219W and 219B, and then creates data of the content of an analysis item according to the calibrated data by considering a calibration curve. The data of the content is written to the data storage 257 together with the assay identification data. Also, the LCD display panel 211 of the terminal device 210 is caused to display the data of the content.

When the transfer tray 206 is pulled out and set at the exit position, the analysis slide 203 is readily exited from the exit channel 209 after the assay. If continuation of the assay is desired, the transfer tray 206 is moved again to the initial set position, to repeat the operation described above. If the assay is terminated, the transfer tray 206 is pressed to thrust in. The power switch is turned off.

The blue and green light components of the blue and green LED chips 232 and 233 are added to the white light component of the white LED chip 231. So light obtained from the LED light source 221 can have a sufficient intensity and sufficient bandwidths. Even in use of the LED light source 221 using lower power than a tungsten lamp, it is possible accurately to obtain data of reference optical density of the reference regions 219W and 219B by light measurement, and data of optical density of the analysis slide 203. The precision of the biochemical analysis can be high. Also, a light source can be a battery because of the use of the LED light source 221 of which required power is lower than a lamp. Also, it is possible to prolong the time during which the biochemical analyzer 202 of the portable type can be used consecutively. The LED chips 231-233 of ready-made products can be used without placing orders of LEDs specialized for the biochemical analysis. This can lower the manufacturing cost of light sources.

Note that the biochemical analyzer 202 is a portable type. However, the biochemical analyzer 202 of the invention may be an analyzer of a large type or desk top type. It is also possible according to the feature of the invention to keep low a consumed power in the analysis.

In place of the blue and green LED chips 232 and 233 above, plural auxiliary light-emitting elements of the invention can be used to emit light of a component of which the light from the white LED chip 231 is short. One of the two auxiliary light-emitting elements can emit light of a wavelength different from 400 nm. A second one of the two auxiliary light-emitting elements can emit light of a wavelength different from 505 nm. Other colors of light disclosed in U.S. Pat. No. 5,477,326 (corresponding to JP-A 8-015016) can be used, in which a red light-emitting element, an infrared light-emitting element and the like are suggested.

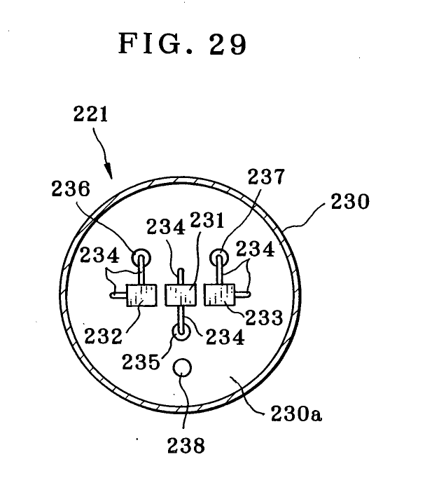

In the above embodiment, the LED chips 231-233 are arranged concentrically about the center. Also, another preferred arrangement is illustrated in FIG. 29. The white LED chip 231 is disposed at the center of the base panel 230a, the white LED chip 231 being associated with light of the most frequently used color. The blue and green LED chips 232 and 233 are disposed so that the white LED chip 231 lies between those. It is preferable that the blue and green LED chips 232 and 233 are equidistant from the white LED chip 231. The blue and green LED chips 232 and 233 may not be disposed directly beside the white LED chip 231, but can be positioned at any suitable locations between which the white LED chip 231 lies. For example. The blue and green LED chips 232 and 233 can be disposed higher or lower than the white LED chip 231, and also can be obliquely higher or lower than the same.

In the above embodiments, the reflected illuminating light from the analysis slide 203 is measured. However, biochemical analysis according to the invention may be analysis of a transmission structure in which illuminating light transmitted through the analysis slide 203 can be measured by the photoreceptors or photo diodes 229.

Although the filter turret 224 has the band-pass filters 241-247 according to the above embodiment, the number of the band-pass filters on the filter turret 224 can be changed as required for the items to be analyzed.

Furthermore, the filter turret 224 may be disposed between the analysis slide 203 and the photoreceptors or photo diodes 229. Only a component of the light reflected by the analysis slide 203 and having a certain wavelength can be rendered incident upon the photo diodes 229 by the band-pass filters 241-247.

In the above embodiment, the terminal device 210 with the LCD display panel 211, the keypad 212 and the analysis processor 256 is separate from the biochemical analyzer 202. However, various elements including the LCD display panel 211, the keypad 212 and the analysis processor 256 can be included in the biochemical analyzer 202.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A light measuring device for light measurement by use of an assay surface and at least one light source, said assay surface being provided with a sample positioned thereon, said light source being oriented to tilt at a predetermined angle with respect to said assay surface, for applying illuminating light to said assay surface, said light measuring device comprising:
a photoreceptor, positioned in a light path extending from said assay surface, for measuring scattered reflected light of diffuse reflection from said assay surface; and
a light absorber, positioned in a light path-of said illuminating light emitted by said light source and reflected in regular reflection by said assay surface, for absorbing said illuminating light.

2. A light measuring device as defined in claim 1, wherein said light absorber includes a light absorbing surface having a color of a high density and a low gloss.

3. A light measuring device as defined in claim 2, further comprising an aperture, positioned between said assay surface and said photoreceptor, for passage of said scattered reflected light in a predetermined region.

4. A light measuring device as defined in claim 2, further comprising a controller for turning on and off said light source;
wherein said photoreceptor responds to turning on of said light source, to output a signal of said scattered reflected light.

5. A light measuring device as defined in claim 2, wherein said at least one light source comprises plural light sources, said at least one light absorber comprises plural light absorbers, said plural light sources and said plural light absorbers are arranged on a circle concentrically about said assay surface.

6. A light measuring device as defined in claim 5, wherein said plural light sources are arranged in one light source train, and said plural light absorbers are arranged in one light absorber train.

7. A light measuring device as defined in claim 3, wherein said at least one light source comprises plural light sources, arranged on a circle concentrically about said assay surface, for light emission at wavelengths different from one another.

8. A light measuring device as defined in claim 3, wherein each of said plural light sources includes at least one light-emitting diode.

9. A light measuring device as defined in claim 3, wherein said light absorber is in a tubular shape, has a first end open toward said assay surface, has a second end being closed, has a black colored inner surface, for trapping said illuminating light from said assay surface.

10. A light measuring device as defined in claim 3, wherein said predetermined angle is 30-60 degrees.

11. A biochemical analyzer comprising:
a light source for illuminating an assay surface oriented to tilt at a predetermined angle;
a photoreceptor, positioned in a light path extending from said assay surface, for measuring scattered reflected light of diffuse reflection from said assay surface where a fluid sample is dropped;
a quantitative analysis unit for quantitatively analyzing said sample according a measuring result of said scattered reflected light; and
a light absorber positioned in a light path in regular reflection by said assay surface illuminated in said light emission of said light source.

12. A biochemical analyzer as defined in claim 11, wherein said assay surface comprises an analysis slide where said sample is dropped.

13. A spectrophotometer for optically assaying a sample by use of an assay surface and a light source, said assay surface being provided with said sample positioned thereon, said light source applying illuminating light to said assay surface, said spectrophotometer comprising:
a spectroscopic device for spectroscopically separating said illuminating light from said assay surface;
a photoreceptor for constituting an optical assay unit of multi-channel spectroscopic measurement, and for detecting said illuminating light from said spectroscopic device per a specific wavelength, to obtain a detection signal;
an arithmetic processor for processing said detection signal from said photoreceptor by weighting with weight information, to obtain a corrected detection signal associated with said specific wavelength, said weight information being associated with respectively plural specific wavelengths, said corrected detection signal being used for analysis of said sample.

14. A spectrophotometer as defined in claim 13, wherein said weight information is determined according to a characteristic difference between said multi-channel spectroscopic measurement and optical band-pass filter measurement for said plural specific wavelengths;
in said analysis of said sample, measured data of said sample is obtained from said corrected detection signal by referring to a calibration curve of said optical band-pass filter measurement.

15. A spectrophotometer as defined in claim 14, wherein said photoreceptor comprises a photoreceptor array of plural photoreceptors, arranged in a wavelength distribution direction of said spectroscopic device, for detecting said illuminating light from said spectroscopic device for respectively said specific wavelength.

16. A spectrophotometer as defined in claim 14, wherein said spectroscopic device comprises diffraction gratings.

17. A spectrophotometer as defined in claim 14, further comprising an A/D converter for converting said detection signal into photoelectric data in a digital form, to output said detection signal to said arithmetic processor.

18. A spectrophotometer as defined in claim 14, wherein said arithmetic processor includes:
an amplifier for amplifying said detection signal at an amplification factor associated with respectively said specific wavelengths; and
an adder for adding up said detection signal being amplified.

19. A spectrophotometer as defined in claim 14, wherein said arithmetic processor includes:
a transmittance distribution optical filter, disposed in a light path of said illuminating light between said spectroscopic device and said photoreceptor, and changeable in transmittance in a wavelength distribution direction; and
an adder for adding up said detection signal output by said photoreceptor.

20. A spectrophotometer as defined in claim 13, wherein an analysis slide is loadable, for constituting said assay surface, wherein said sample reflects said illuminating light with said assay surface, for traveling to said spectroscopic device.

21. A spectrophotometer as defined in claim 13, wherein a sample vessel is loadable, and includes a transparent portion for constituting said assay surface, and contains said sample, wherein said sample and said transparent portion transmit said illuminating light to travel to said spectroscopic device.

22. A spectrophotometer as defined in claim 13, wherein said photoreceptor comprises a photo diode.

23. A biochemical analyzer for optically assaying a sample by use of illuminating light, to analyze said sample, comprising:
a light source for applying said illuminating light to an assay surface where said sample is positioned;
a spectroscopic device for spectroscopically separating said illuminating light from said assay surface;
a photoreceptor for constituting an optical assay unit of multi-channel spectroscopic measurement, and for detecting said illuminating light from said spectroscopic device per a specific wavelength, to obtain a detection signal;
an arithmetic processor for processing said detection signal from said photoreceptor by weighting with weight information, to obtain a corrected detection signal associated with said specific wavelength, said weight information being associated with respectively plural specific wavelengths, said corrected detection signal being used for analysis of said sample.

24. A biochemical analyzer as defined in claim 23, further comprising:
a data storage for storing information of a calibration curve of optical band-pass filter measurement and weight information of weighting and correction with respect to said plural specific wavelengths, said weight information being determined according to a characteristic difference between said multi-channel spectroscopic measurement and said optical band-pass filter measurement;
a quantitative analysis unit for obtaining measured data of said sample from said corrected detection signal by referring to said calibration curve of said optical band-pass filter measurement.

25. A biochemical analyzer as defined in claim 24, wherein said photoreceptor comprises a photoreceptor array of plural photoreceptors, arranged in a wavelength distribution direction of said spectroscopic device, for detecting said illuminating light from said spectroscopic device for respectively said specific wavelength.

26. A biochemical analyzer as defined in claim 25, wherein said spectroscopic device comprises diffraction gratings.

27. A biochemical analysis method comprising steps of:
applying illuminating light to a sample;
spectroscopically separating said illuminating light traveling from said sample;
detecting said illuminating light being separated per a specific wavelength; and
processing a detection signal of said illuminating light per said specific wavelength by weighting with weight information, to obtain a corrected detection signal for said specific wavelength.

28. A biochemical analysis method as defined in claim 27, wherein said detection signal is obtained by multi-channel spectroscopic measurement, and said weight information is determined according to a characteristic difference between said multi-channel spectroscopic measurement and optical band-pass filter measurement;
further comprising steps of:
storing information of a calibration curve of said optical band-pass filter measurement;
obtaining measured data of said sample from said corrected detection signal by referring to said calibration curve of said optical band-pass filter measurement.

29. A biochemical analyzer, including a light source for applying illuminating light to an assay surface provided with a sample positioned thereon, and an optical assay unit for quantitatively analyzing said sample by receiving said illuminating light from said assay surface, said biochemical analyzer comprising:
said light source including:
a white light-emitting element for emitting a white component of said illuminating light; and
at least one additional light-emitting element for emitting a color component of said illuminating light and at a predetermined wavelength, to compensate for shortage of light of said color component.

30. A biochemical analyzer as defined in claim 29, wherein said white light-emitting element and said at least one additional light-emitting element are respectively light-emitting diodes.

31. A biochemical analyzer as defined in claim 29, wherein at least one additional light-emitting element comprises:
a first additional light-emitting element of which said predetermined wavelength is 460 nm or less; and
a second additional light-emitting element of which said predetermined wavelength is equal to or near to 505 nm.

32. A biochemical analyzer as defined in claim 31, wherein said white light-emitting element, said first and second additional light-emitting elements are arranged triangularly.

33. A biochemical analyzer as defined in claim 31, wherein said white light-emitting element is disposed between said first and second additional light-emitting elements.

34. A biochemical analyzer as defined in claim 29, further comprising at least one,optical filter, disposed in a light path of said illuminating light from said light source to said optical assay unit, and having a wavelength selectivity for a specific wavelength band.

35. A biochemical analyzer as defined in claim 34, wherein at least one optical filter comprises plural optical filters of which said specific wavelength band is different from one another;
further comprising a filter selector for setting a selected one of said plural optical filters in said light path.

36. A biochemical analyzer as defined in claim 35, wherein said filter selector includes:
a rotatable filter turret, partially disposed in said light path, for supporting said plural optical filters arranged on a circle concentrically about a pivotal axis thereof; and
a motor for rotating said filter turret.
